(19) United States
(12) Patent Application Publication
(10) Pub. No.: US 2006/0031067 A1
(43) Pub. Date: Feb. 9, 2006

(54) Sound input device

(75) Inventor: Atsunobu Kaminuma, Yokohama-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 11/194,798

(22) Filed: Aug. 2, 2005

(30) Foreign Application Priority Data
Aug. 5, 2004 (JP) P2004-229204
Sep. 17, 2004 (JP) P2004-270772

(51) Int. Cl. G10L 21/02

(52) U.S. Cl. 704/226

(57) ABSTRACT

A sound input device has: a start-of-a-learning-operation determining unit configured to determine a time when a filter is started to be learned, the filter being for removing noise from sound signals detected in a car compartment while leaving object signals; and a frequency band determining unit configured to determine a frequency band for which the filter is learned after the time when the filter is started to be learned is determined.

### BACKGROUND OF THE INVENTION

Recently, a car is equipped with a speech input system in its compartment so that the speech inputting system is widely used, for example, for operating its on-vehicle equipment by means of speech recognition, and for talking on a hands-free automotive telephones by means of speech recognition. Factors of hindering speech recognition include existence of sounds from sound sources other than a speaker using the speech input system.

For this reason, it is necessary to carry out a preliminary process of removing sound (noise), which comes from the sound sources other than the speaker using the speech input system, from sound to be detected in the vehicle compartment.

### SUMMARY OF THE INVENTION

However, if speech and noise are separated in this preliminary process too precisely, this increases an amount of calculation, and accordingly slows the processing speed down.

With this taken into consideration, an object of the present invention is to perform an algorithm, which is used in a highly precise preliminary process of separating speech and noise, with high speed.

In order to solve the aforementioned problems, a sound input device according to the present invention has: a start-of-a-learning-operation determining unit configured to determine a time when a filter is started to be learned, the filter being for removing noise from sound signals detected in a car compartment while leaving object signals; and a frequency band determining unit configured to determine a frequency band for which the filter is learned after the time when the filter is started to be learned is determined.

### BRIEF DESCRIPTION OF THE DRAWINGS

FIG. 1 is a block diagram showing a learning method for obtaining a filter in a speech input device according to a first embodiment of the present invention.

FIG. 2 is a block diagram showing processes to be performed by the filter.

FIG. 3 is a block diagram showing a system of updating the filter.

FIG. 4 is a block diagram showing a system in which the filter performs processes.

FIG. 5 is a block diagram showing an example of a system configuration.

FIG. 6 is a flowchart showing a learning procedure for obtaining the filter.

FIG. 7 is a flowchart showing a learning procedure for obtaining the filter (showing contents of steps S150 and S160 in particular).

FIG. 8 is a flowchart showing a procedure in which the filtering process is applied to inputted signals.

FIG. 9 is a diagram showing an example (a cosine distance) of results of calculation of a cost function, which is an example of discrimination levels.

FIG. 10 is a conceptual diagram showing a relationship between the cost function and the number of learning repetition.

FIG. 11 is a conceptual diagram showing displacement of the cost function J which is caused when a leaning is ended in a case where ΔJ does not exceed a threshold value JT.

FIG. 12 is a flowchart showing a procedure in which a filter of a sound input device according to an embodiment of the present invention is updated in a case where a limit is imposed on the number of learning repetition.

FIG. 13 is a diagram explaining a learning method of obtaining a filter in the sound input device according to the embodiment of the present invention in the case where the limit is imposed on the number of learning repetition.

FIG. 14 is a conceptual diagram showing a relationship between a cost function and the number of learning repetition in the sound input device according to the embodiment of the present invention in the case where frequencies are divided into blocks of frequency bands.

FIG. 15 is a block diagram (Part 1) showing an example of a configuration of a sound input device according to a fourth embodiment of the present invention.

FIG. 16 is a block diagram (Part 2) showing an example of the configuration of the sound input device according to the fourth embodiment of the present invention.

FIG. 17 is a block diagram showing a specific example of the configuration of the sound input device according to the fourth embodiment of the present invention.

FIG. 18 is a block diagram (Part 3) showing an example of the configuration of the sound input device according to the fourth embodiment of the present invention.

FIG. 19 is a block diagram (Part 4) showing an example of the configuration of the sound input device according to the fourth embodiment of the present invention.

FIG. 20 is a block diagram (Part 5) showing an example of the configuration of the sound input device according to the fourth embodiment of the present invention.

FIG. 21 is a flowchart of a procedure in which signals (object signals) are processed in the sound input device according to the fourth embodiment of the present invention.

FIG. 22 is a flowchart of a procedure in which signals (noise signals) are processed in the sound input device according to the fourth embodiment of the present invention.

FIG. 23 is a block diagram (Part 1) showing processes in which signals are processed in the sound input device according to the fourth embodiment of the present invention.

FIG. 24 is a block diagram showing processes in which a filter is calculated in the sound input device according to the fourth embodiment of the present invention.

FIG. 25 is a block diagram (Part 2) showing processes in which signals are processed in the sound input device according to the fourth embodiment of the present invention.

FIG. 26 is a diagram (Part 1) showing how the filter is calculated in the sound input device according to the fourth embodiment of the present invention.

FIG. 27 is a diagram (Part 2) showing how the filter is calculated in the sound input device according to the fourth embodiment of the present invention.

### DETAILED DESCRIPTION OF THE PREFERRED EMBODIMENTS

### First Embodiment

Hereinafter, descriptions will be provided for a learning method for obtaining a filter in a sound input device according to a first embodiment of the present invention, giving a case in which a learning method is applied to an example of ICA.

As a method of separating speech of a speaker using a speech input system from sound which comes from other sound sources, Independent Component Analysis (hereinafter referred to as “ICA”) has been developed. According to ICA, sets of sound signals are obtained respectively through a plurality of acoustic sensors, and only the plurality of sets of sound signals thus obtained are used. Hence, object speech signals are separated out from the sound signals. In this manner, the filter is obtained through learning

If sound signals from sound sources are received by use of k microphones (sensors), and additionally if a property that sound signals from sound sources are statistically independent is used, as many sound sources as the k microphones or a fewer sound sources than the k microphones can be separated. An initial sound source separation method using ICA did not take into consideration time differences in which sounds arrive from the respective sound sources. This made it difficult to apply the initial sound source separation method to a microphone array. However, recently, various techniques have been proposed, which takes time difference into consideration, and which observes a plurality sets of sound signals by use of a microphone array, thus doing an inverse transform which is the opposite of a mixing process in the frequency domain.

Generally, in a case where sound signals coming from l sound sources are observed by k microphones while the sound signals are being linearly mixed, the observed sound signals in a certain frequency f can be expressed by
X(f)=A(f)S(f) (1)
where S(f) denotes a vector representing each of sets of sound signals transmitted from the respective sound sources, X(f) denotes a vector representing observed signals to be observed by a microphone array which is a sound receiving point, and A(f) denotes a mixed matrix representing a spatial acoustic system concerning each sound source and the sound receiving point. S(f), X(f) and A(f) can be expressed by

$$\begin{matrix}S ( f ) = {[ {S}_{1} ( f ) , … , {S}_{L} ( f ) ]}^{T} & ( 2 ) \\ X ( f ) = {[ {X}_{1} ( f ) , … , {X}_{L} ( f ) ]}^{T} & ( 3 ) \\ A ( f ) = [ \begin{matrix}{A}_{11} ( f ) & … & {A}_{1 L} ( f ) \\ ⋮ & ⋰ & ⋮ \\ {A}_{k1} ( f ) & … & {A}_{KL} ( f )\end{matrix} ] & ( 4 )\end{matrix}$$

where the upper-cased letter T indicates a vector transposition. In this case, when the mixed matrix A(f) is known, if a general inverse matrix A(f)⁻ of A(f) is calculated by use of the vector X(f) representing the observed signals to be observed at the sound receiving point, the sound signals S(f) to be transmitted from the sound source can be calculated as follows
S(f)=A(f)⁻X(f) (5)
where A(f)⁻ represents a general inverse matrix of A(f).

In general, however, A(f) is unknown. For this reason, the sound signals S(f) need to be figured out by use of only X(f).

In order to solve this problem, assume that the sound signals S(f) are probabilistically caused, and that the components of S(f) are mutually independent. In this case, the observed signals X(f) are mixed signals. For this reason, the components of X(f) are not independently distributed. With this taken into consideration, independent components included in the observed signals are intended to be found by use of ICA. In other words, a matrix W(f) (hereinafter referred to as an “inverse mixed matrix) for converting X(f), which denotes the vector representing the observed signals, into mutually independent components is calculated, and then the inverse mixed matrix W(f) is applied to X(f), which denotes the vector representing the observed signals (i.e., the product of Matrix W(f) and Matrix X(f) is calculated). Thereby, signals to approximate to the sound signals transmitted from the sound source, whose vector is denoted by S(f), are found.

For a process of doing the inverse transform which is the opposite of the mixing process, a technique of performing the analysis in the time domain, and a technique of performing the analysis in the frequency domain have been proposed. Here, descriptions will be provided for the process of doing the inverse transform which is the opposite of the mixing process, giving an example of the technique of performing the calculation in the frequency domain.

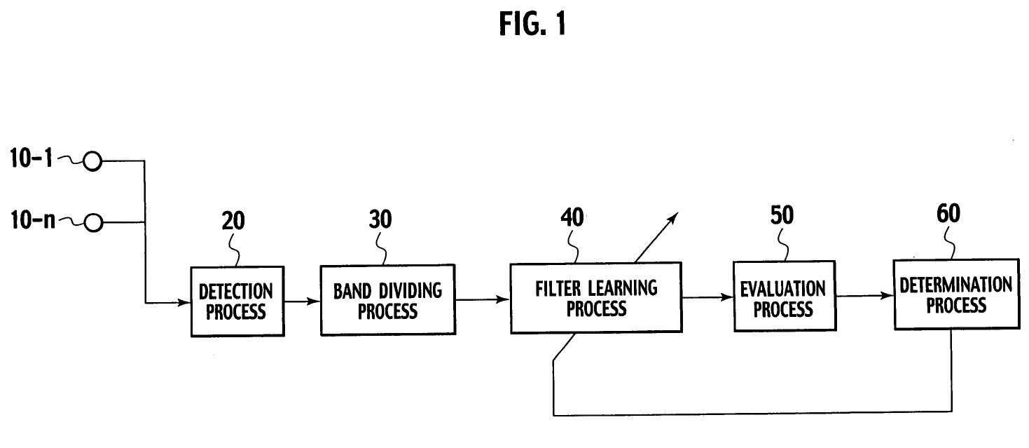

With reference to FIG. 1, descriptions will be provided for a learning method of obtaining a filter, which is a feature of the speech input device according to the first embodiment of the present invention. As shown in FIG. 1, sound in which object speech (speech) and non-object sound (noise) exist in a mixed manner is detected by use of a plurality of microphones 10-1 to 10-n which are acoustic sensors. This is termed as a detection process 20. A plurality of sound signals in which the object speech signals and the non-object sound signals exist in a mixed manner, and which are obtained in the detection process 20, are divided into a plurality of frequency bands in a band dividing process 30. The plurality of sound signals are inputted into a filter leaning process 40, where a filter is obtained through repetition of learnings. According to a method of learning for obtaining the filter, a discrimination level for evaluating performance of separating out object speech which a filter exhibits in the course of repetition of learnings is calculated for each of the divided frequency bands in an evaluation process 50 in the process of repeating the leanings. On the basis of the discrimination level thus calculated, a divided frequency band for which a learning is performed is selected out of the plurality of divided frequency bands in a determination process 60. A result of this selection is fed back to the filter learning process 40. A learning based on the result of the selection is performed. Descriptions will be provided for an example of the discrimination level and a method of calculating the discrimination level later.

First of all, a short-time frame analysis is applied to sets of signals, which are observed by the respective microphones, by use of an adequate orthogonal transformation. At this time, with regard to input through a microphone, complex spectrum values in a specific frequency bin are plotted in the course of inputting through a microphone. The complex spectrum values thus plotted are considered as being in a time sequence. In this respect, the frequency bin shows an individual complex component in a signal vector whose frequency has been converted by means of a short-time discrete Fourier transform. Similarly, the same operation is performed on input through each of the other microphones. The time-frequency signal sequence thus obtained can be expressed by
X(f,t)=[X₁(f,t), . . . ,X_{K}(f,t)]^{T} (6)

Next, signals are separated by use of an inverse mixed matrix W(f). This process can be expressed by
X(f,t)=[X₁(f,t), . . . ,X_{K}(f,t)]^{T}=W(f)X(f,t) (7)
where the inverse mixed matrix W(f) is optimized in a way that L outputs Y(f,t) in the time sequence are mutually independent. These processes are performed on all of the frequency bins. Finally, an inverse orthogonal transformation is applied to each of the separated outputs Y(f,t) in the time sequence, and accordingly time waveforms of the sound source signals are restructured.

An unsupervised learning algorithm based on minimization of the Kullback-Leibler divergence and an algorithm for uncorrelating a quadratic correlation and a higher correlation have been proposed as a method for evaluating the independence and a method for optimizing the inverse mixed matrix.

Incidentally, ICA is used not only for processing sound signals, but also for separating incoming signals, while interfered, from one another in mobile communications, for separating and extracting object signals from signals, which arise from various parts in the human brain, in a case where the brain signals are measured by use of an electroencephalography, an functional magnetic resonance imaging (fMRI), or the like.

Hereinafter, descriptions will be provided for the discrimination level and a method of calculating the discrimination level, which are used in the learning method for obtaining the filter, giving their respective examples.

With regard to a frequency band in which it is difficult to separate signals from one another even if ICA is applied to the frequency band, there are many cases where a value representing the discrimination level, or precision in separating the signals (for example, a cosine distance), is not improved even through tens of learning repetitions. It is redundant to perform calculation for learning in such a frequency band. For this reason, a band in which change in the discrimination level, or the precision in the signal separation, is small may be detected, thus ending the calculation of Frequency-Domain ICA.

Hereinafter, a determination function is introduced, which determines whether or not the calculation of Frequency-Domain IC may be ended.

First of all, the time-frequency signal sequence for which sounds have been collected by use of the respective microphones, and for which a short-time frame analysis has been applied to the sounds, is expressed by
X(f,t)=[X₁(f,t), . . . , X_{K}(f,t)]^{T}
Subsequently, the signals are separated from one another by use of the inverse mixed matrix W(f), which has been optimized by ICA. This process is expressed by Equation (7), where Y(f,t) denotes separated signals, which are obtained by separating the sound sources from one another. In this respect, W(f) denotes a matrix of size L×K, and shows damping characteristics of a filter for separating object speech signals from a plurality of acoustic signals.

Next, with regard to the filter for separating object speech signals from the plurality of acoustic signals, descriptions will be provided for a method of detecting a frequency band in which change in the filter's precision in the signal separation is small. According to the detection method, a cost function for evaluating mutual dependence among the separated signals is defined as the discrimination level for evaluating the filter's performance in separating out object speech, after the learning by use of ICA is completed. Then, on the basis of a rate of change in this cost function, a frequency band in which change in the precision in the signal separation is small is determined. With regard to the cost function, it suffices if, for example, a value representing a higher correlation among the separated signals and the cosine distance are used. In particular, the cosine distance requires a small amount of calculation, and accordingly is efficient. A cost function based on a cosine distance between two sound sources is expressed by

$$J ( f , t ) = \frac{\vert {〈 {Y}_{1} ( f , t ) {{Y}_{2} ( f , t )}^{*} 〉}_{t} \vert}{\sqrt{{〈 {\vert {Y}_{1} ( f , t ) \vert}^{2} 〉}_{t} {〈 {\vert {Y}_{2} ( f , t ) \vert}^{2} 〉}_{t}}} \qquad ( 8 )$$

where symbol ( ), denotes the calculating of the average of time in a local time section, for example, in a time section between time t-200 ms and time t ms, symbol * denotes a complex conjugate. The right-hand side of Equation (8) shows a coefficient representing a correlation between two separated signals Y₁(f,t) and Y₂(f,t) in the local time section. This correlation coefficient is a discrimination level in this case. t on the left-hand side of Equation (8) denotes an upper end in the local time section, or a right-hand end to which time flows on the assumption that time flows from left to right. In this sense, t on the left-hand side of Equation (8) has a meaning different from that of t on the right-hand side of Equation (8).

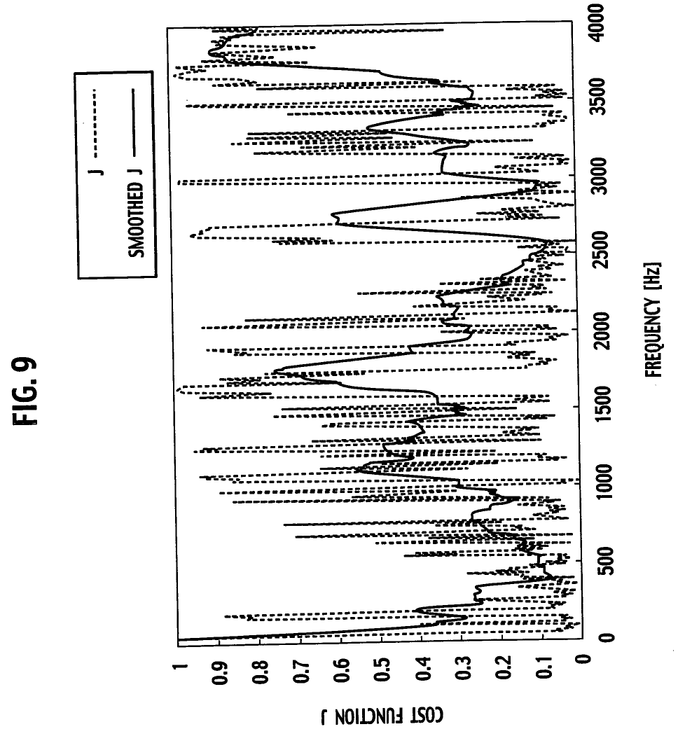

In a case of actual application of the cost function, a value representing the discrimination level is influenced by a position where time is sliced out using a short-time frame analysis and by an equivalent factor. For this reason, it is likely that notable discontinuity may occur between frequencies. An example of such a phenomenon where a discontinuity occurs between frequencies in the cost function is shown by rugged lines in FIG. 9. As a means for avoiding the discontinuity, for example, use of a smoothed cost function, or a smoothed discrimination level, can be conceived. The smoothed cost function can be obtained by calculating a moving average of the cost function expressed by Equation (8) in a width of frequency band. This smoothed cost function can be expressed by

$${J}_{S} ( f , t ) = \frac{1}{B} {\sum }_{{f}_{m} = ( f - B / 2 )}^{( f + B / 2 )} \frac{\vert {〈 {Y}_{1} ( {f}_{m} , t ) {{Y}_{2} ( {f}_{m} , t )}^{*} 〉}_{t} \vert}{\sqrt{{〈 {\vert {Y}_{1} ( {f}_{m} , t ) \vert}^{2} 〉}_{t} {〈 {\vert {Y}_{2} ( {f}_{m} , t ) \vert}^{2} 〉}_{t}}} \qquad ( 9 )$$

where B is a parameter for giving a smoothed width. In this case, the smoothing is implemented in an averaged manner in the local frequency section. This smoothed cost function Jₛ(f,t) takes up a smaller value when the separated signals are mutually independent, and takes up a larger value when the separated signals are not mutually independent. In addition, the maximum value is one.

Furthermore, if a rate ΔJ of change of the cost function is used, this makes it possible to detect frequency bands in which precision in the signal separation is not improved. This rate ΔJ corresponds to the rate of change between discrimination levels. For example, a rate ΔJ_{S}(f,t) of change in a divided frequency band is expressed by
ΔJS(f,t)=∥Jₛ(f,t)−Jₛ(f,t−m)∥ (10)
if the cost function Jₛ(f,t) in the divided frequency band at time t and the cost function Jₛ(f,t−m) in the same divided frequency band at time t−m (m>0) are used.

The right-hand side of Equation (10) indicates an average of a norm of the difference vector Jₛ(f,t)−Jₛ(f,t−m) between the two smoothed discrimination levels, for example, a square of Jₛ(f,t)−J₅(f,t−m), in terms of frequency in this divided frequency band. f on the left-hand side of Equation (10) indicates a frequency representing this divided frequency band, for example, a center frequency in the divided frequency band. f on the left-hand side of Equation (10) has a meaning different from that of f on the right-hand side of Equation (10).

At this time, the determination function B(f) can be expressed by

$$B ( f ) = \{ \begin{matrix}1 , ( Δ {J}_{S} ( f ) > {J}_{T} ) \\ 0 , ( Δ {J}_{S} ( f ) \leq {J}_{T} )\end{matrix} \qquad ( 11 )$$

where J_{T} denotes a threshold value which is beforehand set for the purpose of the determination. If B(f)=1, it is determined that a learning calculation be performed in the divided frequency band represented by f. If B(f)=0, it is determined that a learning calculation be not performed in the divided frequency band represented by f.

Equation (11) makes it possible to automatically detect a frequency band which has a possibility of improvement in the precision in the signal separation without beforehand using information on the sound source. Like Jₛ(f,t), a smoothing may be applied to ΔJₛ(f,t) with influence on a plurality of frequency bands taken into consideration. Otherwise, J(f,t) may be used as it is instead of Jₛ(f,t).

The descriptions have been provided for the learning method for the filter in the sound input device according to the first embodiment, giving the case where two sound sources exist. However, even in a case where there are three sound sources or more, if the aforementioned method is applied to each of the sound sources, this brings about the same effect of the first embodiment.

Hereinafter, descriptions will be provided for a configuration of the sound input device according to the first embodiment of the present invention.

FIG. 1 is a block diagram showing processes in which the filter is updated in the case of the first embodiment. In FIG. 1, microphones 10-1 to 10-n are a plurality of acoustic sensors, which detect sound in which object speech and non-object sound exist in a mixed manner, and which output the detected sound in the form of a plurality of acoustic signals in which object speech signals and non-object sound signals exist in a mixed manner. In a detection process 20, the acoustic signals as outputs from the microphones 10-1 to 10-n is detected, and is converted to discrete signals. In a band dividing process 30, the discrete signals are broken down into frequencies, and the frequencies are divided into divided frequency bands. A general method of converting signals to frequencies is FFT. However, any conversion method may be used as long as the conversion method is in a category of an orthogonal transformation including a wavelet transform and a z transform.

A filter learning process 40 is a process for obtaining a filter for separating at least one object speech signal from the plurality of acoustic signals, which have been divided into the divided frequency bands through learning repetitions. Any learning method may be used as long as the learning method is a method, according to which the learning is performed for each of the frequencies. In the case of this embodiment, Frequency-Domain ICA is used.

An evaluation process 50 is a process in which the discriminate level is calculated for each of the divided frequency bands. The discrimination level indicates evaluation of performance which the filter to be obtained in the filter learning process 40 exhibits in separating out the object speech. A determination process 60 is a process for determining a divided frequency band, for which a learning calculation is performed, on the basis of the discrimination levels which have been calculated in the evaluation process 50. A result of this determination is fed back to the filter learning process 40. Incidentally, the evaluation process 50 and the determination process 60 do not have to be performed each time the learning is repeated in the filter learning process 40. For example, the processes 50 and 60 may be performed once each time the learning is repeated 10 times. Otherwise, the processes 50 and 60 may be performed every time the learning is performed immediate after the learning is initiated, and thereafter may be performed once each time the learning is repeated 10 times.

According to a specific method of determining a divided frequency band for which a learning calculation is performed, it is determined that the learning calculation be not performed in learning repetitions at and after time t, with regard to a divided frequency band in which a rate of change between a discrimination level calculated at time t−m (m>0) and a discrimination level calculated at time t does not exceed a previously-set threshold value. In this case, with regard to a divided frequency band in which a rate of change between a discrimination level calculated at time t−m (m>0) and a discrimination level calculated at time t exceeds the previously-set threshold value, the following two determinations are made according to the specific method.

1. In a case where a divided frequency band, for which a learning calculation is performed at and after time t, is again determined, it is determined that the learning calculation be performed in the learning repetitions from time t until a time when the determination is made.

2. In a case where a divided frequency band, for which a learning calculation is performed at and after time t, is no longer determined so that the learning repetition process is ended, it is determined that the learning calculation be performed in the learning repetitions from time t until a time when the learning repetition process is ended.

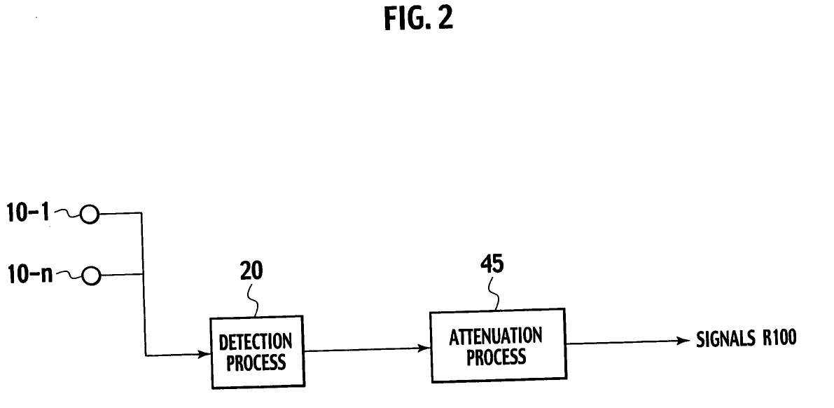

After the leaning is ended, the filter obtained in the filter learning process 40 is used as contents of an attenuation process 45 shown in FIG. 2.

In this manner, useless calculation is omitted in the adaptive learning to be performed for each of the divided frequency bands. This makes it possible to reduce an amount of calculation during the filter learning.

For example, J(f,t) shown in Equation (8) may be used as the aforementioned discrimination levels. In addition, ΔJ_{S}(f,t) shown in Equation (10) may be used as the rate of change between the discrimination levels.

FIG. 2 is a block diagram showing processes in which the filter is process. The acoustic signals in which the object speech signals and the non-object sound signals exist in a mixed manner are outputs from the microphones 10-1 to 10-n. The acoustic signals are converted to the discrete signals in the detection process 20. The discrete signals are outputted as the object speech signals (signals R100) through the attenuation process 45 whose contents is the filter which has been obtained in the filter learning process 40. The attenuation process 45 is a process in which the object speech signals are extracted from the inputted acoustic signals, or the non-object sound signals are suppressed.

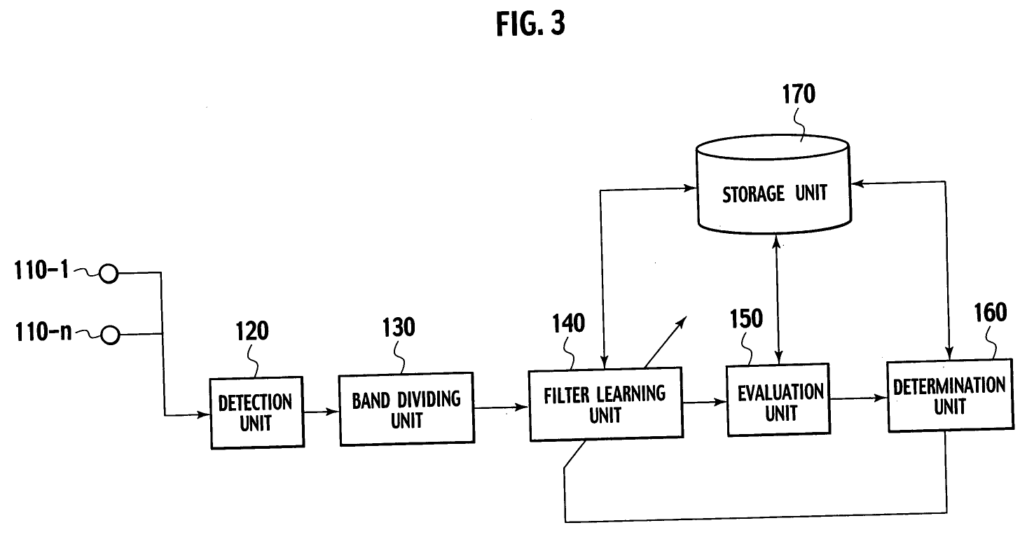

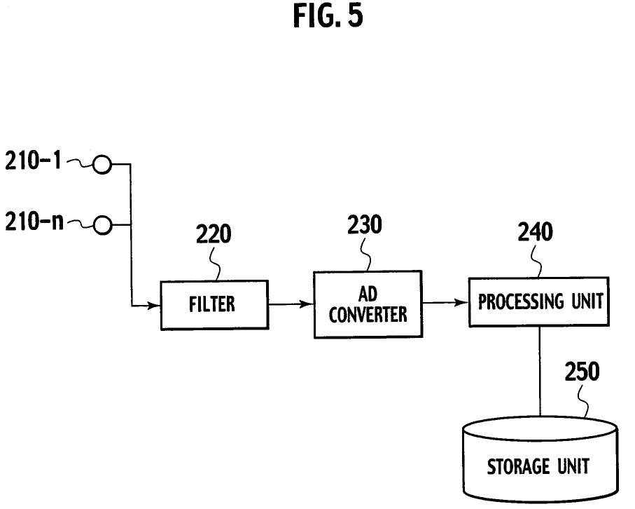

FIG. 3 is a block diagram showing a system for updating the filter. Generally-used microphones can be used as microphones 110-1 to 110-n. A detection unit 120 corresponds to a filter (anti-aliasing filter) 220, an AD converter 230 and a processing unit 240 in FIG. 5, and is configured by means of combining generally-used operation circuits including a CPU, an MPU, a DSP and an FPGA. A band dividing unit 130 corresponds to the processing unit 240 and a storage unit 250 in FIG. 5. A filter learning unit 140 corresponds to the processing unit 240 and the storage unit 250 in FIG. 5. An evaluation unit 150 corresponds to the processing unit 240 and the storage unit 250 in FIG. 5. A determination unit 160 corresponds to the processing unit 240 and the storage unit 250 in FIG. 5.

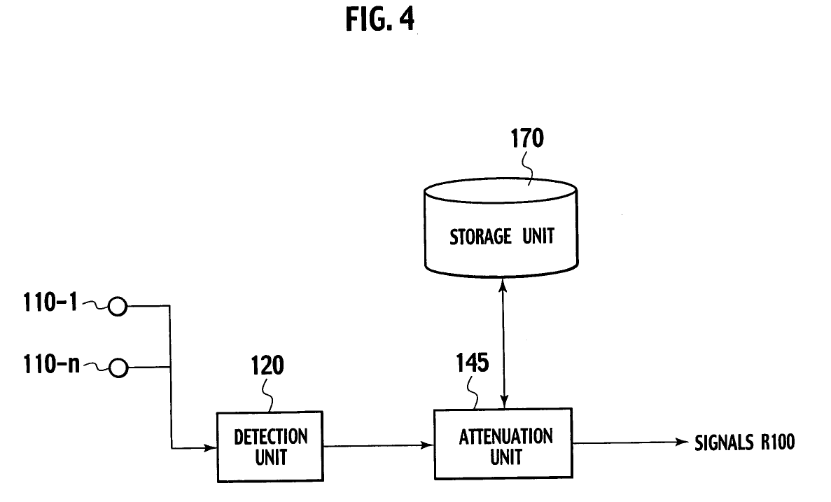

FIG. 4 is a block diagram showing a system for performing a filtering process. Microphones 110-1 to 110-n and a detection unit 120 are the same as those which have been shown in FIG. 3. An attenuation unit 145 corresponds to the processing unit 240 and the storage unit 250 in FIG. 5. A storage unit 170 corresponds to the storage unit 250 in FIG. 5, and is configured by means of combining generally-used storage media including a cache memory, a main memory, a HDD, a CD, a MD, a DVD, an optical disc and an FDD.

FIG. 5 is a block diagram showing an example of a system configuration. Acoustic signals which are outputs from microphones 210-1 to 210-n are inputted into an AD converter through a filter 220. After an AD conversion is applied to the acoustic signals, the signals are inputted into the processing unit 240. Thus, the acoustic signals are processed. The filter 220 is used for removing noise which is included in the acoustic signals.

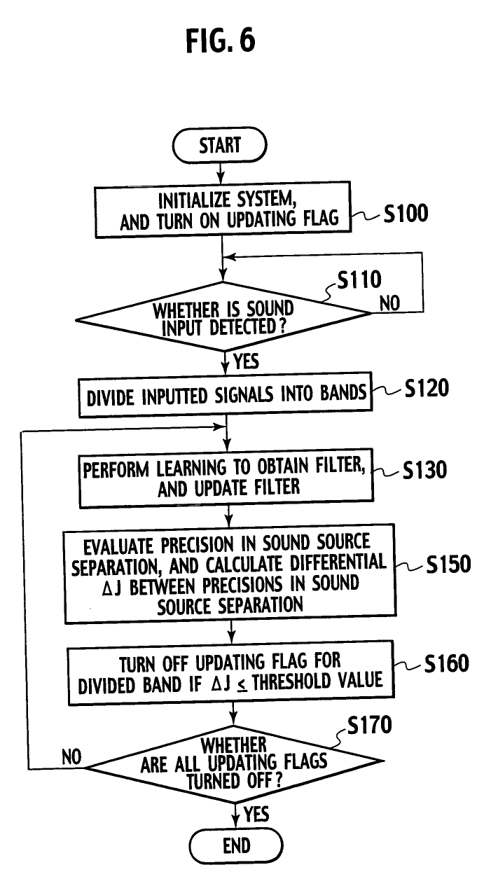

FIG. 6 is a flowchart of procedures through which the learning is performed in order to obtain the filter. Reference numerals steps S100 to S170 denote mutually-independent processes.

In step S100, the system is initialized, and an operation of reading into the memory is performed.

In step S110, sound input is detected. After the detection, the process proceeds to step S120.

In step S120, the inputted signals are divided into frequency bands. A frequency band for each frequency bin may be fixed or variable.

In step S130, the learning is performed in order to obtain the filter, and the filter is updated. For example, Frequency-Domain ICA is used.

In step S 150, precision in separating out the sound source at time t, or a discrimination level Jₜ at time t, is calculated. In addition, a rate ΔJ of change between the discrimination level Jₜ at time t and a discrimination level Jₜ₋ₘ at time t−m is calculated. The discrimination level Jₜ at time t is stored.

In step S160, an updating flag is checked, and the flag is set. In other words, if ΔJ≦a threshold value, the flag for the divided frequency band is turned off.

In step S170, another updating flag is checked. If all of the updating flag have been turned off, the learning is ended. If there remains an updating flag which has not been turned off, the process returns to step S140.

A filter for which the learning has been completed is assigned as a filter to be used in the attenuation process 45.

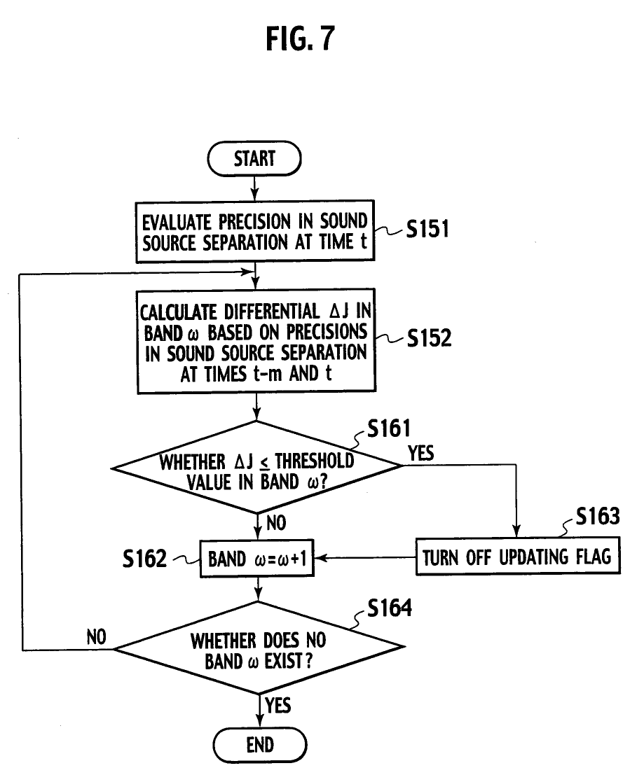

FIG. 7 is a flowchart showing a learning procedure for obtaining the filter (showing contents of steps S150 and S160 in particular).

In step S151, the discrimination level Jₜ at time t (a cosine distance between signals in a case where there exist two sound sources or more, for example) is calculated.

In step S152, the rate ΔJ of change in discrimination level is calculated on the basis of the discrimination level Jₜ₋ₘ at time t-m (m>0) and the discrimination level Jₜ at time t in a divided frequency band ω.

In step S161 if ΔJ_{S} the threshold value in the divided frequency band ω, the process proceeds to step S163. If not, the process proceeds to step W162.

In step S162, the divided frequency band ωis updated. Subsequently, the process proceeds to step S164.

In step S163, the updating flag is turned off.

In step S164, in a case where there exists no divided frequency band ω, this flow of processes is ended. In a case where there exists a divided frequency band ω, the process returns to step S152.

In the above-described flow of processes, it is determined that the learning calculation be not performed in the learning repletion at and after time t with regard to a divided frequency band in which the rate M of change between the discrimination level Jₜ₋ₘ calculated at time t-m (m>0) and the discrimination level Jₜ calculated at time t does not exceed the threshold value which has been set beforehand.

In addition, in the above-described flow of processes, the following two determinations are made with regard to a divided frequency band in which the rate ΔJ of change between the discrimination level Jₜ₋ₘ at time t-m (m>0) and the discrimination level Jₜ at time t is larger than the threshold value which has been set beforehand. First, in the case where a divided frequency band, for which a learning calculation is performed at and after time t, is again determined, it is determined that the learning calculation be performed in the learning repetitions from time t until a time when the determination is made. Second, in the case where a divided frequency band, for which a learning calculation is performed determined at and after time t, is no longer so that the learning repetition process is ended, it is determined that the learning calculation be performed in the learning repetitions from time t until a time when the learning repetition process is ended.

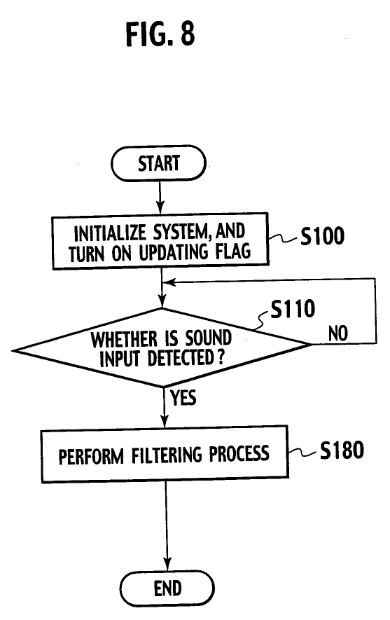

FIG. 8 is a flowchart showing a procedure in which the filtering process is applied to inputted signals.

In step S100, the system is initialized, and an operation of reading the filter into the memory is performed.

In step S110, sound input is detected. After the detection, the process proceeds to step S180.

In step S180, the filter process is applied to the inputted signals, and the resultant object speech signals are transmitted.

FIG. 9 is a diagram showing an example (a cosine distance) of results of calculation of a cost function, which is an example of the discrimination levels. In FIG. 9, the horizontal axis indicates frequencies, and the vertical axis indicates values to be taken up by the cots function (for example, cosine distances). A rugged line (fine line) indicates values which are obtained by calculating the cost function. The other line (bold line) indicates values to be obtained by smoothing the values which have been obtained by calculating the cost function. The result of calculation of the cost function can be obtained through tens to hundreds of learning repetitions. As the value to be taken up by the cost function comes nearer to 1 (one), it is more highly probable that signals are not separated well. In divided frequency bands, for example, which have frequencies lower than 100 Hz, or which have frequencies not lower than 3,500 Hz, the cost function takes up a larger value. For this reason, it is expected that precision in separating signals becomes lower in such divided frequency bands. An initial value is a value near to 1 (one) in every divided frequency band. The value to be taken up by the cost function becomes smaller through learning repetitions.

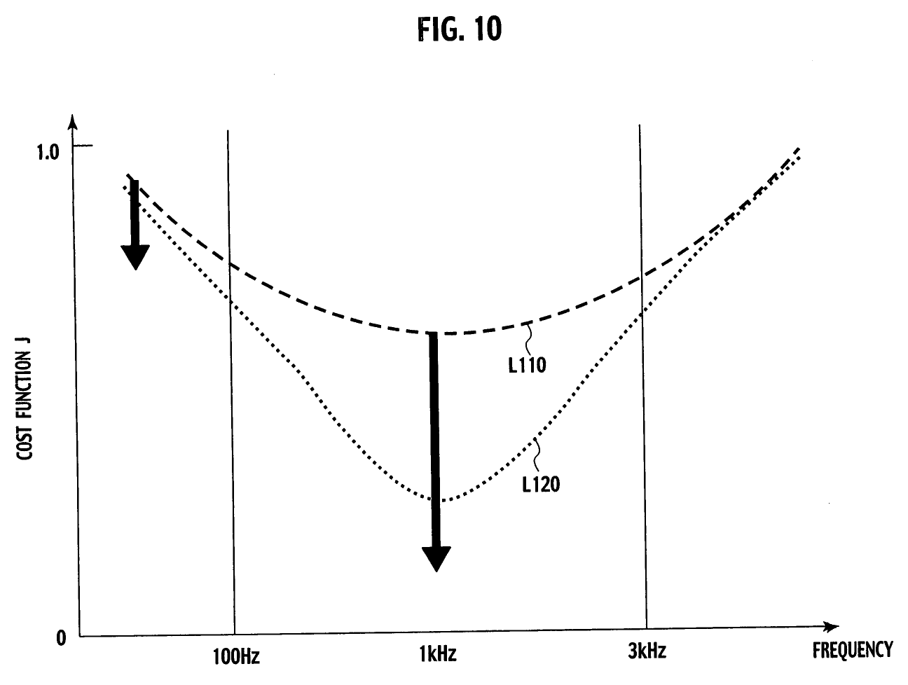

FIG. 10 is a conceptual diagram showing a relationship between the cost function and the number of learning repetitions. The horizontal axis indicates frequencies, and the vertical axis indicates values to be taken up by the cots function (for example, the cosine distances). Reference numeral L110 conceptually indicates values which are taken up by the cost function in a case where Frequency-Domain ICA is calculated through 10 times of learning repetitions. Reference numeral L120 conceptually indicates values which are taken up by the cost function in a case where Frequency-Domain ICA is calculated through twenty times of learning repetitions. In the vicinity of a frequency of lkHz, a rate of change from L110 to L120 is larger. In the vicinities of frequencies of 100 Hz and 3 kHz, a rate of change from L110 to L120 is smaller.

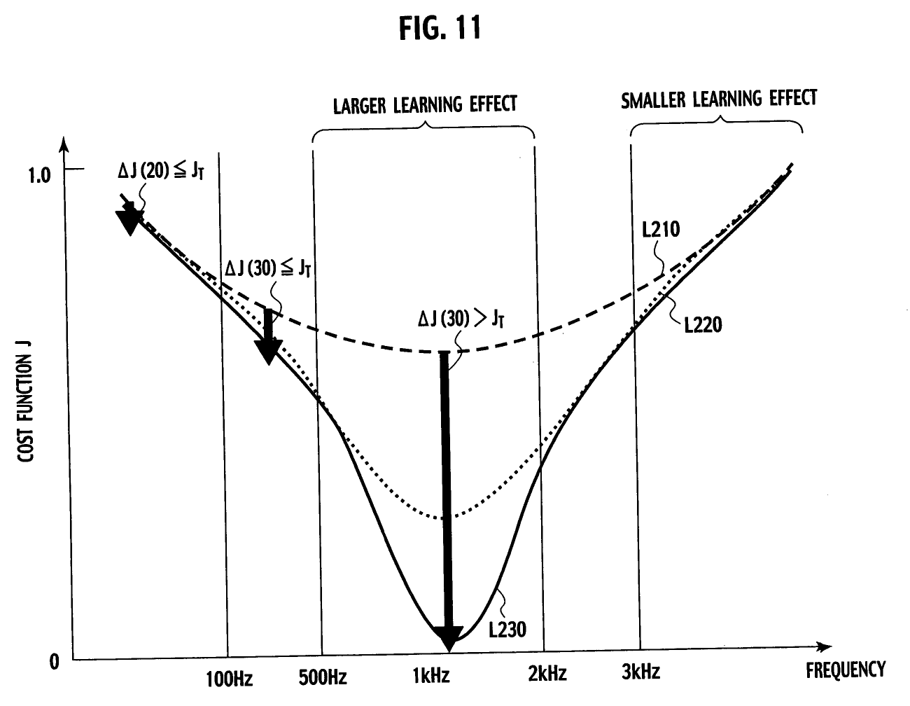

FIG. 11 is a conceptual diagram showing displacement of the cost function J which is caused when the leaning is ended in a case where ΔJ does not exceed a threshold value J_{T}. Reference numeral L210 (the dashed line) indicates values to be taken up by the cost function J for the respective frequencies in a case where the learning is repeated 10 times. Reference numeral L220 (the dotted line) indicates values to be taken up by the cost function J for the respective frequencies in a case where the learning is repeated 20 times. Reference numeral L230 (the continuous line) indicates values to be taken up by the cost function J for the respective frequencies in a case where the learning is repeated 30 times. With regard to a divided frequency band in which the rate ΔJ of change (in the case of 20 times of learning repetitions) does not exceed the threshold value J_{T} when the cost function is displaced from L210 to L220, or a divided frequency band (lower than 100 Hz and not lower than 3 kHz) in which ΔJ (in the case of 20 times of learning repetitions) ≧J_{T}, the learning is ended when the number of learning repetition reaches 20 times. Thereafter, the learning calculation is not performed. With regard to a divided frequency band in which the rate ΔJ of change (in the case of 30 times of learning repetitions) does not exceed the threshold value J_{T} when the cost function is displaced from L220 to L230, or a divided frequency band (lower than 500 Hz and not lower than 2 kHz) in which ΔJ (in the case of 30 times of learning repetitions) ≦J_{T} the learning is ended immediately. Thereafter, the learning calculation is not performed.

In the case of the first embodiment of the present invention, it is determined, in the aforementioned manner, that the learning calculation be not performed for divided frequency bands in which a desirable learning effect is not brought about whenever deemed necessary. This makes it possible to reduce an amount of calculation to be carried out while the learning is being performed in order to obtain the filter.

### Second Embodiment

Specific examples of the performing of the evaluation process 50 in FIG. 1 include the below-mentioned cases.

(Case 1)

The evaluation process 50 is performed each time the learning is repeated. In other words, each time the learning is repeated, the discrimination level is calculated, and a rate of change between the discrimination level of this time and a discrimination level of the immediately preceding time calculation is calculated. Thereby, an evaluation is performed. This makes it possible to most precisely determine frequency bands in which the learning is perform. However, this increases an amount of calculation. If the processing speed of the CPU is sufficiently high, this evaluation process 50 can be practically performed.

(Case 2)

The evaluation process 50 is performed once each time the learning is repeated 10 times. In other words, the evaluation process to be performed at time t is designed to be performed repeatedly at time t+i, where i=10μ when the length of time which it takes the learning to be performed once during learning repetition is defined as u. This makes it possible to reduce an amount of calculation to a large extent in comparison with Case 1. It may be determined how many times the learning is designed to be repeated before the evaluation process 50 is performed once, or how many times i is designed to be as large as u, with the environment and an amount of calculation taken into consideration.

(Case 3)

The length of time m is defined as a length of time 5μ, which is as long as the length of time needed to repeat the learning 5 times. If m=u, the learning is terminated erroneously in a divided frequency band, in which an learning effect can be expected, in some cases. However, if the length of time m is defined as being that long, only with less probability does the error occur. In other words, the definition of m as 5μmakes the calculation robust against a minute change, and less susceptible to the minute change.

(Case 4)

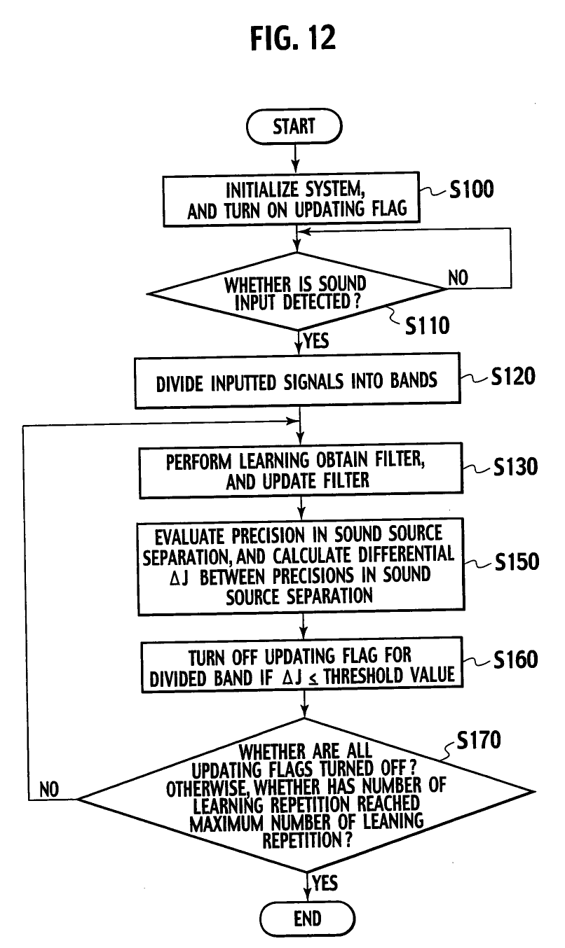

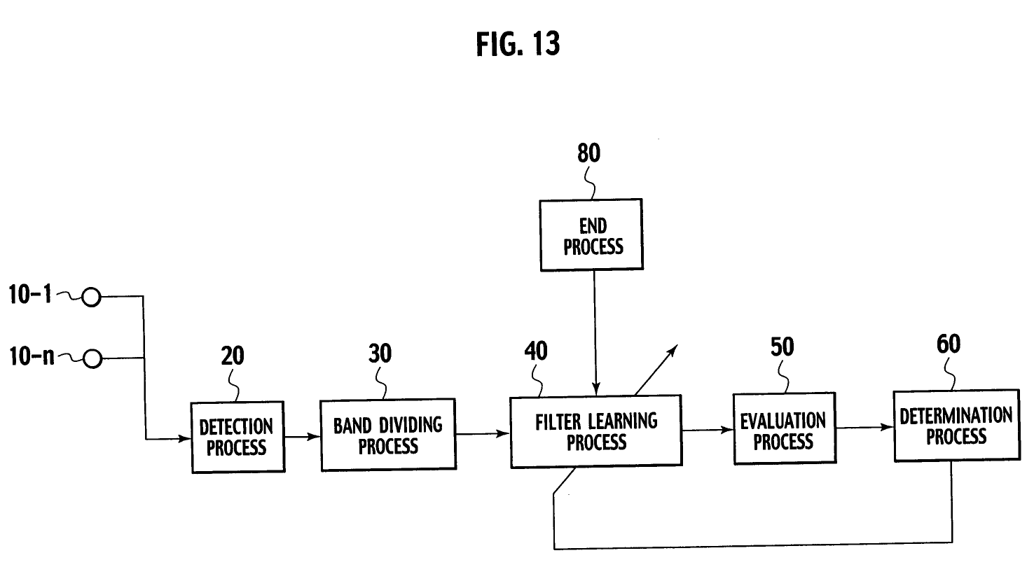

Time at which to suspend the learning is defined as a time at which several times of the learning repletion are completed. If the threshold value J_{T} is set inadequately, the learning is repeated too many times. In order to avoid the excessive repetition of the learning, a procedure for setting time at which to suspend the learning is installed in the flow of the learning repetition. This makes it possible to reduce an amount of calculation for evaluation and determination. In a simplest form, the learning operation may be ended when the number of times that the learning is repeated reaches a predetermined value. In this case, a procedure for ending the learning when the number of times that the learning is repeated reaches a maximum number of learning repetition is included in step S170, as shown in FIG. 12. In addition, an end process 80 for ending the learning is provided, as shown in FIG. 13.

(Case 5)

A sum of values of this time, the penultimate time, and two times before this time is adopted as values representing Jₜ and Jₜ₋ₘ. Otherwise, An average of values of this time, the penultimate time, and two times before this time is adopted as values representing Jₜ and Jₜ₋ₘ. This adoption makes the calculation robust against a minute change and less susceptible to the minute change.

(Case 6)

In Cases 1 to 4, J₅(j,t) and J₅(j,t−m) which are expressed by Equation (9) are used as J, and Jₜ₋ₘ, as well as ΔJ₅(j,t) which is expressed by Equation (10) is used as ΔJ. Otherwise, J(j,t) and J(j,t−m) which are expressed by Equation (8) are used as Jₜ and Jₜ₋ₘ, as well as ΔJ(j,t) which is expressed by Equation (12) is used as ΔJ
ΔJ(f,t)=∥J(f,t)−J(f,t−m)∥ (12)
where the expression on the right-hand side has the same meaning as that of Equation (10).

### Third Embodiment

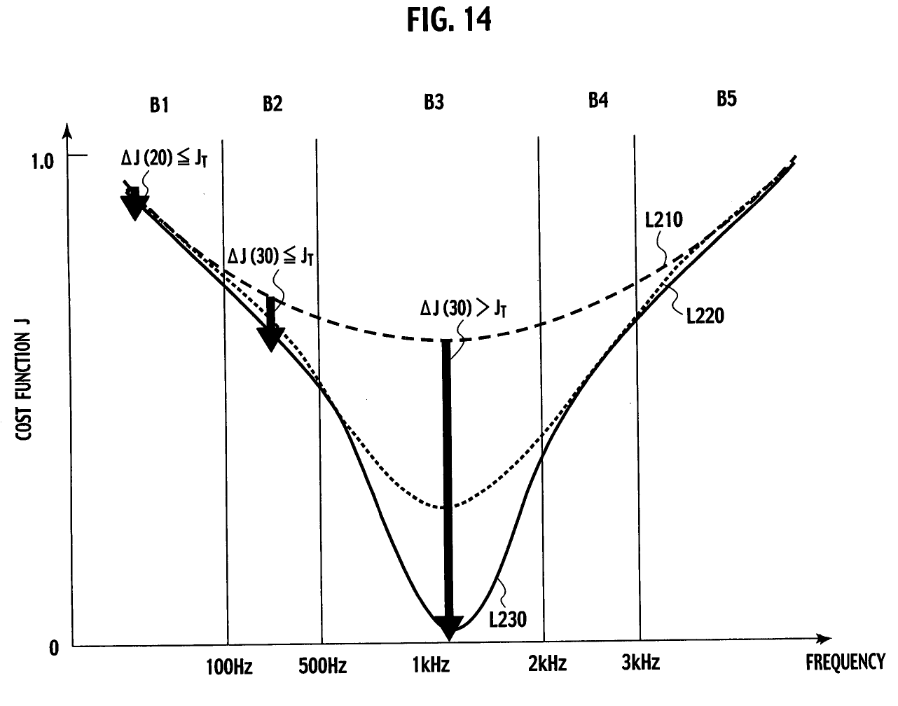

The divided frequency bands are grouped into a plurality of blocks. It is determined that no learning calculation be performed in the learning repetition for all of divided frequency bands belonging to a block for which it is determined that the learning calculation be not performed in the learning repetition. One example of this determination is shown in FIG. 14. In FIG. 14, the divided frequency bands (not illustrated) are grouped into 5 blocks B1 to B5. The number of the divided frequency bands is not smaller than the number of the blocks. Reference numerals B1 and B5 indicate that the learning is ended when the number of learning repetitions reached 10. Reference numerals B2 and B4 indicate that the learning is ended when the number of learning repetitions reached 20. Reference numerals B3 indicates that the learning is ended when the number of learning repetitions reached 30. The grouping of this kind makes it possible to reduce an amount of calculation concerning the evaluation and determination.

As described above, the first to the third embodiments bring about technical effects, which will be described below.

Problems with the processes of separating object signals based on the conventional ICA can be listed as follows.

First of all, although the conventional ICA uses statistical independence among signals which have been transmitted from a signal source, it is difficult for the conventional ICA to precisely estimate an amount of statistics in an actual environment because of transmission characteristics of the signals, background noise and the like. This decreases the precision in the signal source separation.

In addition, it is difficult to regard a diffusive signal source as a single signal source. This makes it very difficult to separate signal sources.

In order to solve the problems, a technique has been proposed as the related art. The technique is to eliminate influence of the diffusive signal source in the course of ICA calculation. According to this technique, precision in separating sound sources is estimated depending on the size of a value to be taken up by the cost function which is calculated for each frequency in the course of ICA calculation. A process of making response by the filter smaller (hereinafter referred to “SBE”, which stands for Sub-Band Eliminate) is applied to a frequency in which precision in separating sound sources is low. In SBE, it is determined whether or not precision in separating sound sources exceeds a threshold value for each frequency. For this reason, an amount of calculation for SBE is larger than that for a general Frequency-Domain ICA.

Objects of each of the sound input devices according to the first to the third embodiments of the present invention are threefold. This problem is corrected. An amount of calculation for each of the sound input devices according to the first to the third embodiments is only slightly larger than that for SBE to be applied to the general Frequency-Domain ICA. Diffusive noise is reduced.

Each of the sound input devices according to the first to the third embodiments of the present invention acquires sound signals from a plurality of acoustic sensors, and uses only a plurality sets of sound signals thus acquired, thereby performing Independent Component Analysis for obtaining a filter for separating object speech signals from the sound signals through learning. Each of the sound input devices divides the acoustic frequency band into a plurality of divided frequency bands. For each divided frequency band, each of the sound input devices calculates a discrimination level for evaluating performance in separating out object speech, which the filter obtained through the learning exhibits, in the course of the learning repetition. On the basis of the discrimination level thus calculated, each of the sound input devices determines a divided frequency band, for which the learning is performed, out of the divided frequency bands.

This produces the following three effects. First, the number of times that the learning is repeated can be reduced in a divided frequency band in which a desirable learning effect is not brought about. An amount of calculation is only slightly larger than that for SBE to be applied to the general Frequency-Domain ICA. Diffusive noise is reduced.

### Fourth Embodiment

In the case of a sound input device according to a fourth embodiment of the present invention, an adaptive method, such as a directional noise reduction algorithm, which needs a large amount of calculation can be used as an algorithm for reducing noise reduction in a car compartment.

The sound input device according to the fourth embodiment of the present invention is effectively applied particularly to a car compartment for the following reasons.

Many of general adaptive filtering techniques have an object to sequentially update the filter by use of inputted sound signals, and to accordingly calculate an optimal filter anytime. With regard to these techniques, the more complicatedly an algorithm is constructed, the more performance is improved. However, a problem with these techniques is that, if a complicated algorithm is constructed, the algorithm increases an amount of calculation. For example, in a case where the process is performed by use of a generally-used personal computer, it takes 30 seconds to tens of minutes to adapt a filter. In the ensuing filtering process, it takes 0.5 approximately seconds to 6 seconds to process data which has been acquired for approximately 4 seconds.

In this manner, the calculation cost is extremely high for the filter adaptation. For this reason, it is impossible to use a generally-used adaptive filtering technique for a sound input system installed in a car compartment. However, the sound input system installed in a car compartment has the following characteristics:

Positions of speakers and positions from which noise occurs are not largely changed.

In the case of a private car, the number of speakers can be limited to several.

Much of noise which occurs in the car compartment is predictable.

Noise which occurs in the car compartment varies with time. These mean that, even if the filter adaptation process is performed constantly, the filter coefficient is actually hardly updated in many cases. In other words, even if the filtering adaptation process is performed only when characteristics of the sound input system in the car compartment change extremely instead of sequentially updating the filter, the S/N ratio can be maintained at a certain level.

Hereinafter, descriptions will be provided for a configuration of the sound input device according to the fourth embodiment of the present invention, giving an example of a sound inputting device placed in the environment of the car compartment. However, the present invention is not limited to this.

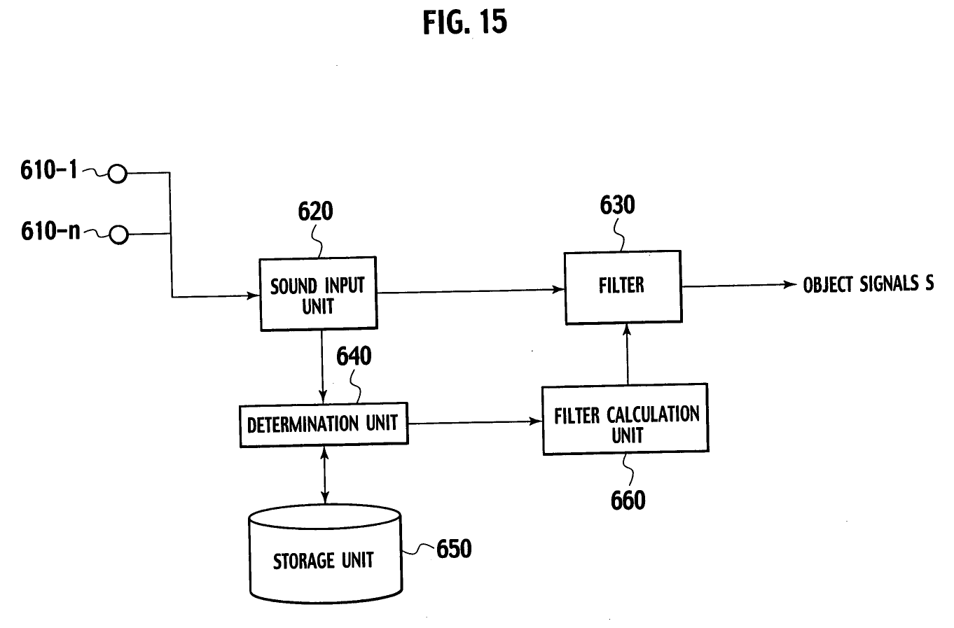

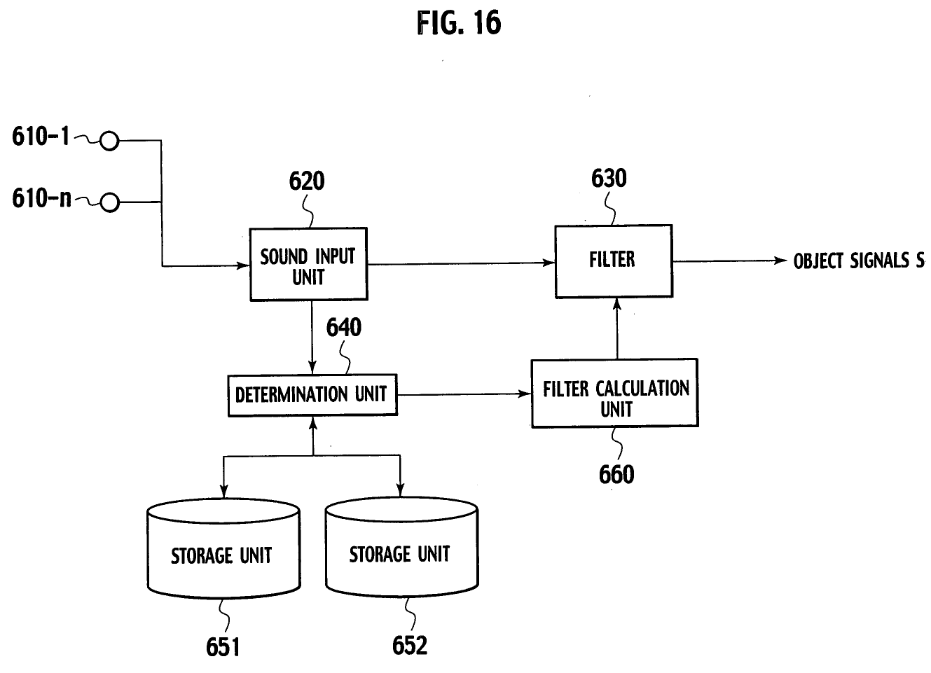

FIGS. 15 and 16 are respectively block diagrams showing an example of the configuration of the sound input device according to the fourth embodiment of the present invention.

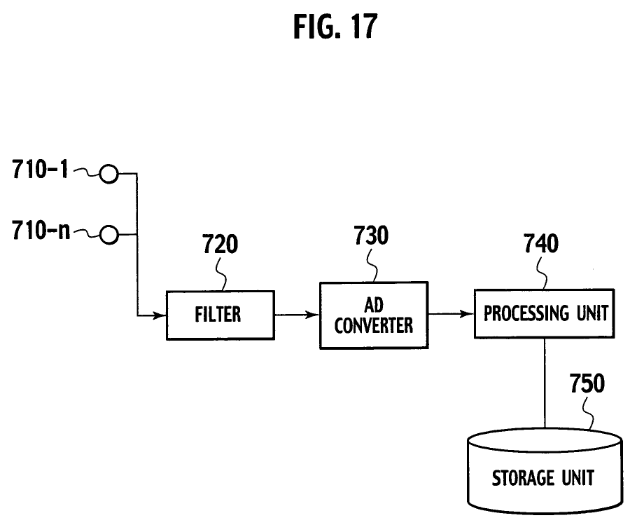

Microphones 610-1 to 610-n (n≧1; n is an integer; and n indicates the number of microphones) for detecting sound, which are shown in FIGS. 15 and 16, collect speech uttered by the user and environmental noise, and converts them to electric signals. This can be achieved by use of microphones, which are denoted by reference numerals 710-1 to 710-n in FIG. 17. Incidentally, only the microphones 610-1 to 610-n are shown in FIGS. 15 and 16.

In a sound input unit 620 as shown in FIGS. 15 and 16, electric signals to be inputted from the microphones 610-1 to 610-n are converted to signals in an easy-to-process form by means of converting the electric signals from analog signals to digital signals. This can be achieved by use of a filter 720 and an AD converter 730 which is a real-time signal digitizing device, both of which are shown in FIG. 17, as well as the like. At this point, the electric signals are replaced with digital sound signals through the AD conversion process.

A filter 630, as shown in FIGS. 15 and 16, for removing noise components from the sound to be inputted through the sound input unit 620 removes noise components from the inputted sound signals. Thereby, the filter 630 transmits object signals S which are signals representing speech which the user intends to input into a peripheral device. This can be achieved by use of a processing unit 740 and a storage unit 750, which are shown in FIG. 17. For example, a CPU, an MPU and a DSP may be used alone or in combination with one another for the processing unit 740. Each of the CPU, the MPU and the DSP constitutes a system with a processing function like a personal computer, a microcomputer and a signal processing device, which are generally used. It is advantageous that the CPU, the MPU and the DPS to be used for the processing unit 740 have a processing capability which enables a real-time process to be performed. A cache memory, a main memory, a disc memory, a flash memory, a ROM and the like may be used for the storage unit 750. Each of these memories is a device with a capability of storing information, which is used for a generally-used information processing device.

A filter calculation unit 660 as shown in FIGS. 15 and 16 calculates a new filter on the basis of information on the inputted noise components and the object signals, accordingly updating contents of the filter 630. Depending on the necessity, the filter calculation unit 660 causes storage units 650, 651 or 652 to store information on the noise which has been used for the update, or information on the object signals which has been used for the update.

The storage unit 650 as shown in FIG. 15 and the storage units 651 and 652 as shown in FIG. 16 store the inputted information on the noise components and the object signals. This can be achieved by use of the storage unit 750 as shown in FIG. 17. Incidentally, each of the storage unit 650, 651 and 652 plays a role of at least one of a first storage unit, a second storage unit and a third storage unit. The first storage unit stores the information on the noise. The second storage unit stores the information on the object signals. The third storage unit stores the information on the object signals and the noise components.

A determination unit 640 as shown in FIGS. 15 and 16 determines whether or not the filter calculation unit 660 as shown in FIGS. 15 and 16 is to be operated, on the basis of the inputted information on the noise components and the object signals. This can be achieved by use of the processing unit 740 and the storage unit 750 as shown in FIG. 17. The determination unit 640 determines that the filter calculation unit 660 be operated on one of the following two conditions. First, sound signals to be acquired through the sound input unit 620 include object signals which the user has inputted, and the object signals thus inputted are different in kind from the object signals to be stored by the second storage unit 650, 651 or 652. Second, sound signals to be acquired through the sound input unit 620 include object signals which the user has inputted, and noise components in sound signals to be acquired through the sound input unit 620 are different in kind from the noise components to be stored by the first storage unit 650, 651 or 652. Incidentally, the determination unit 640 makes the following three types of determinations in addition to the aforementioned type of determination. For example, a first type of determination is whether or not the filter calculation 660 is to be operated depending on the necessity. A second type of determination is whether sound signals to be inputted through the sound input unit 620 are objects signals or constituted of noise components only. A third type of determination is that the sound signals to be inputted through the sound input unit 620 be stored as object signals into the second storage unit 650, 651 or 652, in a case where an analysis of the sound signals brings about an analytical result that noise components are negligible against the object signals. Otherwise, the third type of determination is that the sound signals be stored as noise components into the first storage unit 650, 651 and 652, in a case where the analysis brings about a analytical result that no object signals exist in the sound signals.

In this respect, information on the noise signals includes information which can be obtained from the noise signals, such as the noise signals per se, direction of the noise signals, signals to be obtained by analyzing the noise signals by use of an orthogonal transformation, power of the noise signals, signals concerning cepstrums of the noise signals, time differential signals of sound signals.

In addition, information on the object signals includes information which can be obtained from the speech signals, such as the speech signals per se, signals to be obtained by analyzing the speech signals by use of an orthogonal transformation, power of the speech signals, direction of the speech signals, cepstrums of the speech signals, melceptrums of the speech signals, time differential signals of the speech signals.

According to the aforementioned configuration, the filter can be updated only when noise components which are different from the previously stored noise components are detected. This configuration enables the calculation cost to be made smaller than that involved in the technique of updating a filter each time object signals are inputted.

Furthermore, the filter can be updated when object signals vary in kind. If the filter is designed to be updated only when object signals whose characteristics are different from those of the previously stored object signals are inputted, this configuration enables the calculation cost to be made smaller than that involved in the technique of updating a filter each time object signals are inputted.

Moreover, when object signals or noise vary, the filter can be updated. If the filter is designed to be updated only when object signals or noise, characteristics of which are different from those of the previously stored object signals or noise, are inputted, this configuration enables the calculation cost to be made smaller than that involved in the technique of updating a filter each time object signals are inputted.

A configuration as shown FIGS. 15 and 16 makes it possible to detect incoming directions respectively of the object signals and the noise components, if two or more microphones 610-1 to 610-n (n≧2) are used. If the filter is designed to be updated only when object signals coming in a direction different from the incoming direction of the previously-stored object signals are inputted or when noise components coming in a direction different from the incoming direction of the previously-stored noise components are inputted, this configuration enables the calculation cost to be made smaller than that involved in the technique of updating a filter each time object signals are inputted.

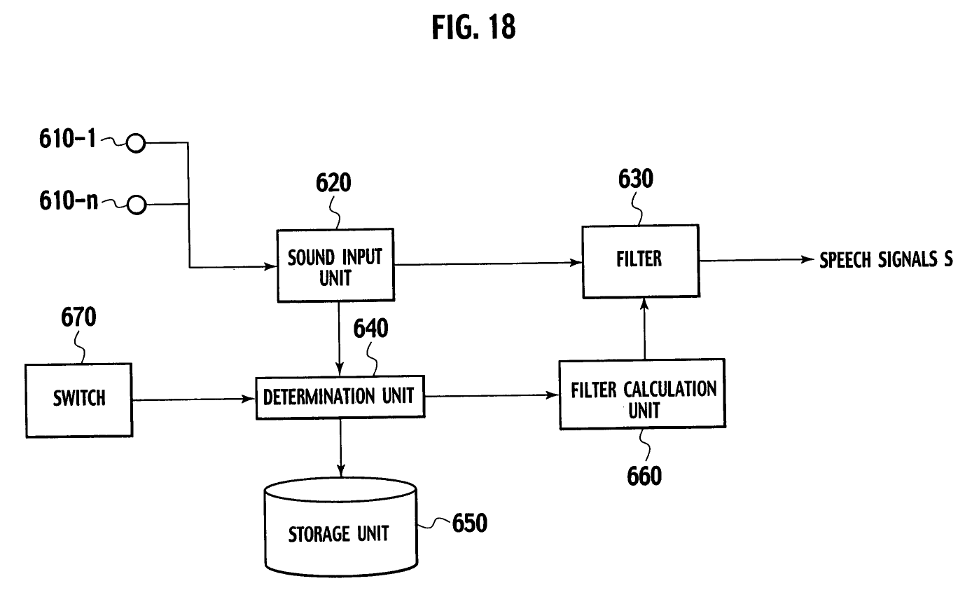

Next, descriptions will be provided for information, other than information on sound signals, to be inputted into the determination unit 640, with reference to FIGS. 18 to 20.

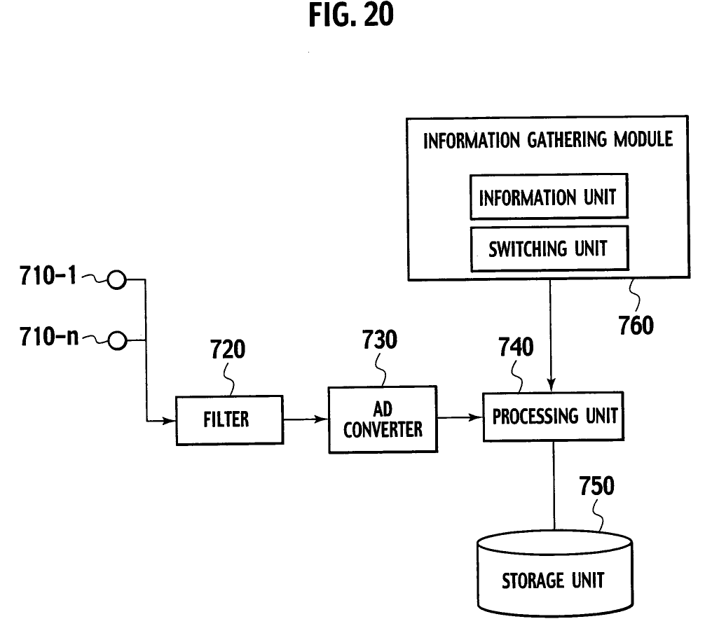

A switch 670 as shown in FIG. 18 transmits information on whether a switch to be used in the environment where the sound input device according to the fourth embodiment of the present invention is installed is on or off. This can be achieved by use of switching devices in a processing unit 740 and an information gathering module 760, both of which are shown in FIG. 20. Specifically, a toggle switch which has an on/off function, a jog dial, a joy stick, a mouse, a track ball, a force-feedback switch and the like are used alone or in combination with one another.

If the switch 670 is used in order for the user to inform the system of whether or not object signals are inputted, the determination unit 640 can determine that the object signals are inputted, when the switch 670 is turned on.

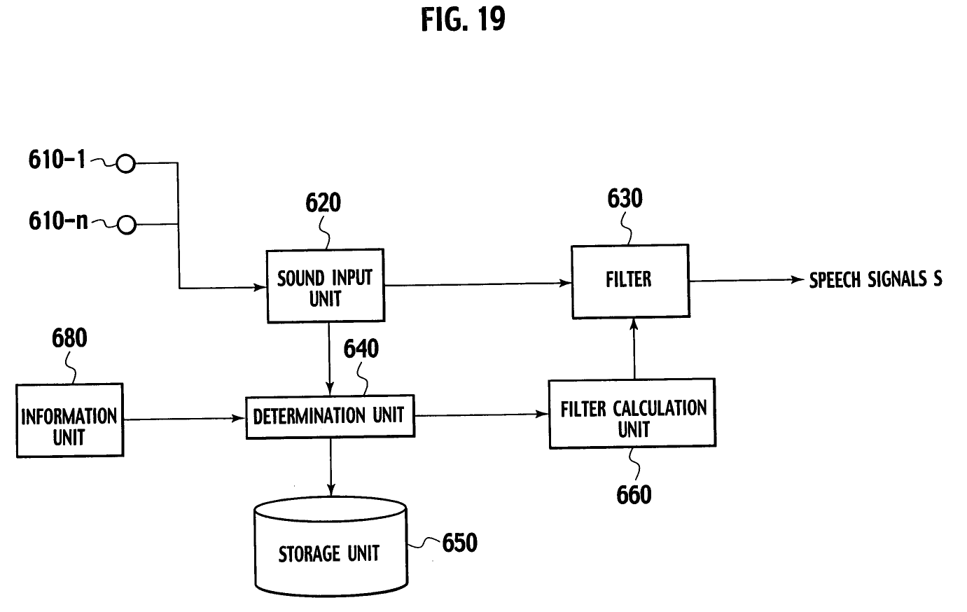

An information unit 680, as shown in FIG. 19, for gathering information on anything but sound transmits information on conditions of other devices to be operated in the environment where the sound input device according to the fourth embodiment of the present invention is installed. The determination unit 640 determines that a filter calculation unit 660 be operated, in a case where the determination unit 640 interprets noise as having varied on the basis of information transmitted from the information unit 680.

The information on conditions of the other devices is information through which to directly or indirectly predict noise, which the other devices will cause, on the basis of conditions in which the other devices operate. In other words, the information on conditions of the other devices includes among other things: information on the vehicle speed; information on the operation of the air conditioner; information on whether the windows are opened or closed; information on the positions respectively of the seats; information on persons in the car; information on the vehicle's main body; information to be obtained through sensors and camera mounted inside or outside the car compartment; information on the tires; information on object devices to be operated which are mounted inside the car compartment. Information on blow levels on the air conditioner and information on a speed at which the car is running can be listed as specific examples of the information on conditions of the other devices.

The gathering of these pieces of information and the determination based on the information thus gathered can be achieved by use of a processing unit 740 and the information gathering module 760, both of which are shown in FIG. 20. Objects on which information is gathered includes a controller for controlling a wind speed of the air conditioner, a vehicle-speed pulse generator, a camera and a sensor, among other things.

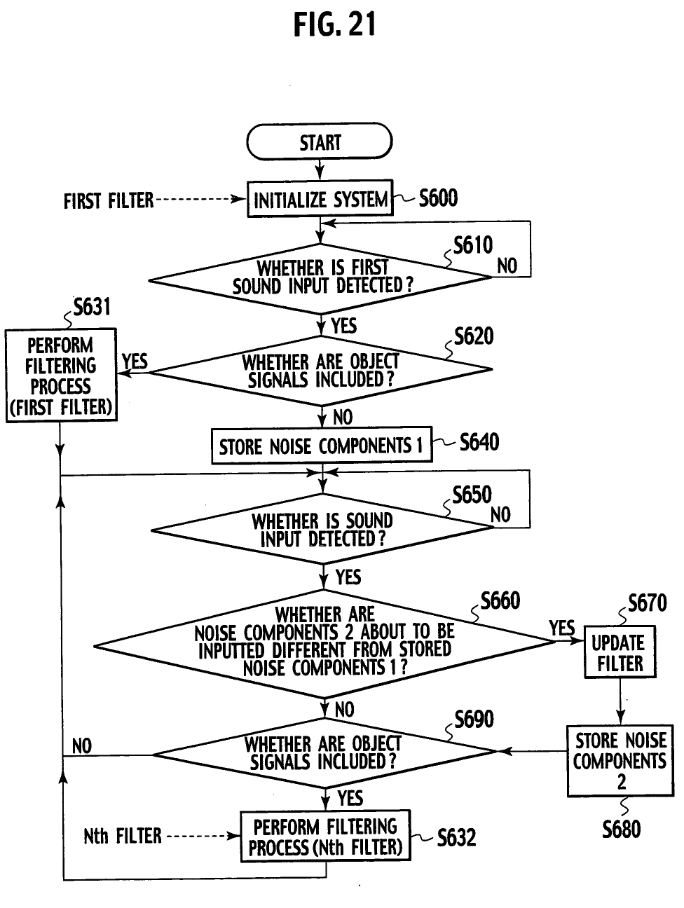

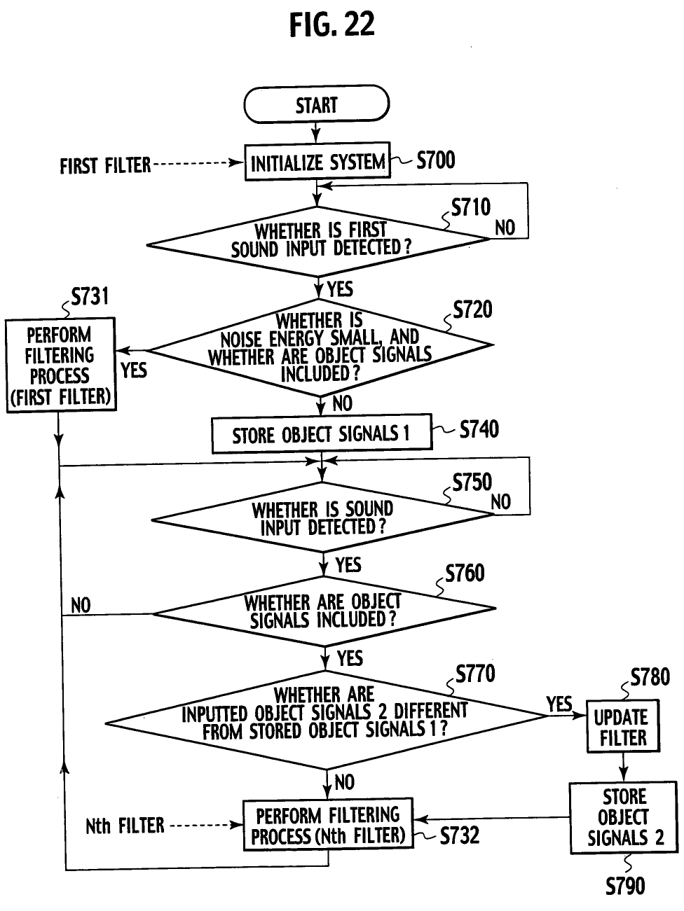

With reference to FIGS. 21 and 22, descriptions will be provided for a flow of processes to be performed in the case of the fourth embodiment of the present invention.

FIG. 21 is a flowchart showing a processing system to be adapted when characteristics of object signals change.

When the system starts its operation, first of all, the system is initialized in stage S600. At this time, a filter for n=1 is read in as the initial condition, and is expanded in the memory.

In stage S610, it is determined whether or not sound has been inputted. There are two cases in the stage of inputting sound; one case where the user inputs object signals intentionally, and the other case where the system is always in an “input” state. In the former case, it is determined that sound has been inputted. In the latter case, it is determined that sound is always being inputted. In both cases, the process proceeds to stage S620 when sound is detected having been inputted. In both cases, stage S610 is repeated when no sound is detected having being inputted.

In a case where it is determined, in stage S620, that object signals are included in the inputted sound signals, the process proceeds to stage S631. In a case where it is determined, in stage S620, that there is a signal section where no object signals, but only noise signals, exist in the inputted sound signals, the process proceeds to stage S640.

In stage S631, a filtering process is applied to the inputted sound signals, and the post-processed sound signals are transmitted to another system.

In stage S640, information on noise components 1, which have been inputted in stage S620, is stored. In this respect, the information on noise components includes information which can be obtained from the noise signals. For example, the information on noise components includes: the noise signals per se; the direction of the noise signals; signals which are obtained by analyzing the noise signals by use of an orthogonal transformation; power of the noise signals; and signals concerning cepstrums of the noise signals. In addition, in a case where this system is achieved for a vehicle, the information on noise components includes: information on a level at which the air conditioner is operated; information on how wide the windows are opened; information on the number of revolutions of the engine; information on a vehicle speed; information on whether or not a fellow passenger moves his/her body; information on whether or not the fellow passenger utters speech; information on whether or not the turn signal lamps are operated; information on a level at which the wipers are operated; information on conditions in which the audio system is operated; driving information from the car navigation system; information on noise which is obtained through a sensor installed inside the car compartment; information which is obtained through cameras installed inside and outside the car compartment; and information which can be indirectly obtained through means for acquiring information on noise. In a case where information on other noise components has already been stored in a storage unit 750, the already-stored information may be replaced with newly-acquired information. Otherwise, the newly-acquired information may be added to the existing information on the noise components 1.

The processes concerning stages S610, S620, S631 and S640 are performed once only after the system is delivered from the factory. It is natural that the process be configured to proceed from stage S600 directly to stage S650 once the processes concerning stages S610, S620, S631 and S640 have been performed.

In stage S650, it is determined whether or not sound has been inputted.

There are two cases in the stage of inputting sound; one case where the user inputs object signals intentionally, and the other case where the system is always in an “input” state. In the former case, it is determined that sound has been inputted. In the latter case, it is determined that sound is always being inputted. In both cases, the process proceeds to stage S660 when sound is detected having been inputted. In both cases, stage S650 is repeated when no sound is detected having being inputted.

In stage S660, information on noise components 2 which are included in the inputted sound signals is compared with the information on the noise components 1 which has been stored. If the “difference” between the information on the noise components 2 and the information on the noise components 1 is detected exceeding a predetermined threshold value, the process proceeds to stage S670. If the “difference” is not detected exceeding the predetermined threshold value, the process proceeds to S690. For example, when “the air conditioner is switched on” is obtained as the information on the noise components 2 in a case where the information on the noise components 1 is “the air conditioner is switched off,” the “difference” is detected exceeding the threshold value in stage S660. Examples of use of information on sound signals includes a procedure in which a spectrum of noise components 2 to be included immediately before the inputted sound signals is analyzed, and accordingly the spectrum of the noise components 2 is compared with the spectrum envelope of the previously-stored noise components 1, and thereby the “difference” is detected exceeding the predetermined threshold value in a case where the spectral distortion exceeds a certain threshold value.

In stage S670, a filter adaptive to the current noise components 2 is calculated, and the filter is updated as the n th filter. There are two cases for inputted signals to be used for this filter calculation: a case where sound signals to be inputted in stage S650 are used as the inputted signals, and the other case where information on the previously-stored noise components 1 is used as the inputted signals.

In stage S680, the information on noise components 2 is stored as the information on noise components 1. At this time, the old noise components 1 may be deleted. Otherwise, the information on noise components 2 may be stored as information to be added to the information on noise components 1.

In stage S690, it is checked whether or not object signals are included in the inputted sound signals. In a case where the object signals are included in the inputted sound signals, the process proceeds to stage S632. In a case where there is a signal section where no object signals, but only noise signals, exist in the inputted sound signals, the process returns to stage S650.

In stage S632, a filtering process is applied to the inputted sound signals. Contents of the filter at this time are the same as those of the filter which has been updated for the n th time. The post-processed sound signals are transmitted to another system. The process in the processing system returns to stage S650.

The processes from stage S650 through stage S680 can be performed even in a case where the user does not inputs object signals intentionally. In other words, if the processes from stage S650 through stage S680 are performed in the case where an action is not taken for inputting speech, this makes it possible to preclude delay in processes which would otherwise cause as a consequence of the processes from stage S650 through stage S680.

FIG. 22 is a flowchart showing a processing system to be adapted when characteristics of object signals change.

When the system starts its operation, first of all, the system is initialized in stage S700. At this time, a filter for n=1 is read in as the initial condition, and is expanded in the memory.

In stage S710, it is determined whether or not sound has been inputted. There are two cases in the stage of inputting sound; one case where the user inputs object signals intentionally, and the other case where the system is always in an “input” state. In the former case, it is determined that sound has been inputted. In the latter case, it is determined that sound is always being inputted. In both cases, the process proceeds to stage S720 when sound is detected having been inputted. In both cases, stage S710 is repeated when no sound is detected having being inputted.

In a case where it is determined, in stage S720, that noise components in the inputted sound signals are at a low level, and that object signals are included in the inputted sound signals, the process proceeds to stage S731. In a case where it is determined, in stage S720, that there is a signal section where no object signals, but only noise signals, exist in the inputted sound signals, the process proceeds to stage S740.

In stage S731, a filtering process is applied to the inputted sound signals, and the post-processed sound signals are transmitted to another system.

In stage S740, information on object signals 1, which have been inputted in stage S720, is stored. In this respect, the object signals means signals which the user intends to input into another system. For example, the object signals are speech signals. In addition, the information on the object signals includes information which can be obtained from the object signals by use of signal processing techniques. For example, the information on the object signals includes: the object signals per se; the direction of the object signals; signals which are obtained by analyzing the object signals by use of an orthogonal transformation; power of the object signals; and signals concerning cepstrums of the object signals. In addition, in a case where this system is achieved for a vehicle, the information on object signals includes: information on a position at which the user is seated; information on object signals which can be acquired through a sensor installed inside the car compartment; information on a position at which the user utters speech, which information can be acquired through a camera installed inside the car compartment; and information which can be indirectly obtained through means for acquiring information on object signals. In a case where information on other object signals has already been stored in a storage unit 750, the already-stored information may be replaced with newly-acquired information. Otherwise, the newly-acquired information may be added to the existing information on the object signals 1.

The processes concerning stages S710, S720, S731 and S740 are performed once only after the system is delivered from the factory. It is natural that the process be configured to proceed from stage S700 directly to stage S750 once the processes concerning stages S710, S720, S731 and S740 have been performed.

In stage S750, it is determined whether or not sound has been inputted. There are two cases in the stage of inputting sound; one case where the user inputs object signals intentionally, and the other case where the system is always in an “input” state. In the former case, it is determined that sound has been inputted. In the latter case, it is determined that sound is always being inputted. In both cases, the process proceeds to stage S760 when sound is detected having been inputted. In both cases, stage S750 is repeated when no sound is detected having being inputted.

In a case where it is determined, in stage S760, that noise components in the inputted sound signals are at a low level, and that object signals are included in the inputted sound signals, the process proceeds to stage S770. In a case where it is determined, in stage S760, that no object signals exist in the inputted sound signals, or that, although object signals exist in the inputted sound signals, the noise components are at a high level, the process returns to stage S750.

In stage S770, information on object signals 2 which are included in the inputted sound signals is compared with the information on the object signals 1 which has been stored. If the “difference” between the information on the noise components 2 and the information on the noise components 1 is detected exceeding a predetermined threshold value, the process proceeds to stage S780. If the “difference” is not detected exceeding the predetermined threshold value, the process proceeds to S732. The following procedure can be listed as an example of use of information on sound signals. According to the procedure, the incoming direction of object signals 2 to be included immediately before the inputted sound signals is compared with the incoming direction of the stored object signals 1, and thereby the “difference” between the two directions is detected in a case where the “difference” is detected exceeding a certain threshold value.

In stage S780, a filter adaptive to the current object signals 2 is calculated, nd the filter is updated as the n th filter. There are two cases for inputted ignals to be used for this filter calculation: a case where speech signals to be nputted in stage S750 are used as the inputted signals, and the other case where information on the previously-stored object signals 1 is used as the inputted signals.

In stage S790, the information on object signals 2 is stored as the information on object signals 1. At this time, the old object signals 1 may be deleted. Otherwise, the information on object signals 2 may be stored as information to be added to the information on object signals 1.

In stage S732, a filtering process is applied to the inputted sound signals. Contents of the filter at this time are the same as those of the filter which has been updated for the n th time. The post-processed sound signals are transmitted to another system. The process in the processing system returns to stage S750.

Hereinafter, descriptions will be provided for an adaptive algorithm to be used for removing near-stationary noise when an observation is performed for a short period of time, giving an example of application of the adaptive algorithm to the filter and the filter calculating process in the sound input device according to the fourth embodiment of the present invention. An adaptive algorithm such as the LMS algorithm can be used for the adaptive algorithm to be used for removing near-stationary noise.

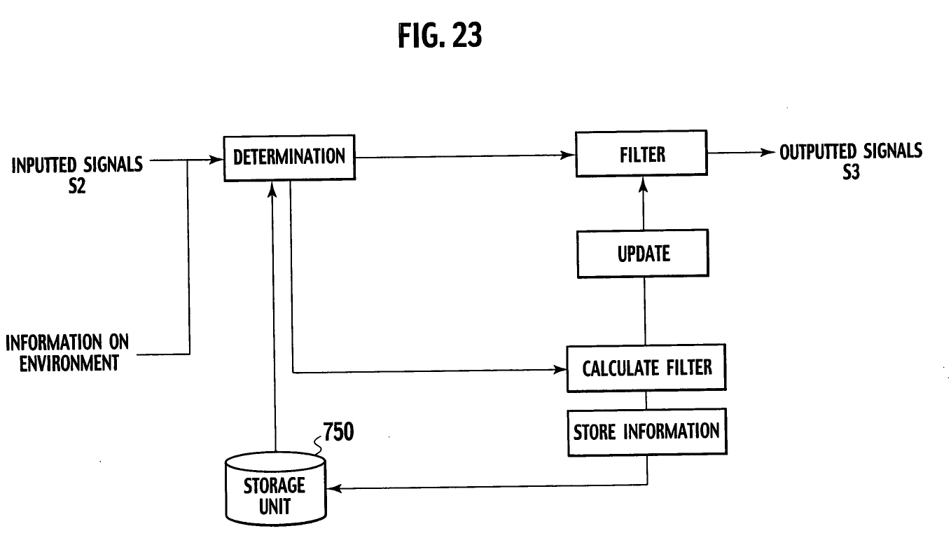

Below, descriptions will be provided for a flow of processes according to the fourth embodiment of the present invention in which the algorithm is used, with reference to FIG. 23.

In the case of the sound input device according to the fourth embodiment of the present invention, operations concerning the filter processing and operations concerning the filter learning are independent of each other. Object signals S1 and information I1 are stored in a storage unit 750 which is equivalent to the third storage unit, or a combination of the first and the second storages. The object signals S1 are inputted at a time (time t₀) when levels of noise components are low. The information I1 is on noise components which are inputted at time t₁. Incidentally, the object signals S1 is object signals which are obtained by extracting inputted sound signals. Each of the information I1 and information I2 which is described below includes any one of the below-described two types of information or both of the two. One type of information is on noise components which are obtained by extracting inputted sound signals. The other type of information is information on operating conditions of devices which is obtained by extracting inputted environmental information.

When sound signals S2 are inputted at time t₂, the below-listed determinations are made depending on conditions.

Condition 1: When the sound signals represent only noise components, and when no difference exists between the information I1 and the information I2 on the inputted noise components, the process returns to a state of waiting for sound signals to be inputted.

Condition 2: When the sound signals represent only noise components, and when a difference exists between the information I1 and the information I2 on the inputted noise components, a “filter calculation” process is performed, and accordingly contents of the “filter” is updated.

Condition 3: When the sound signals are signals in which object signals and noise components are superposed on each other, the “filtering” process is applied to the sound signals S2, and the sound signals S2 thus processed are outputted as outputted signals S3.

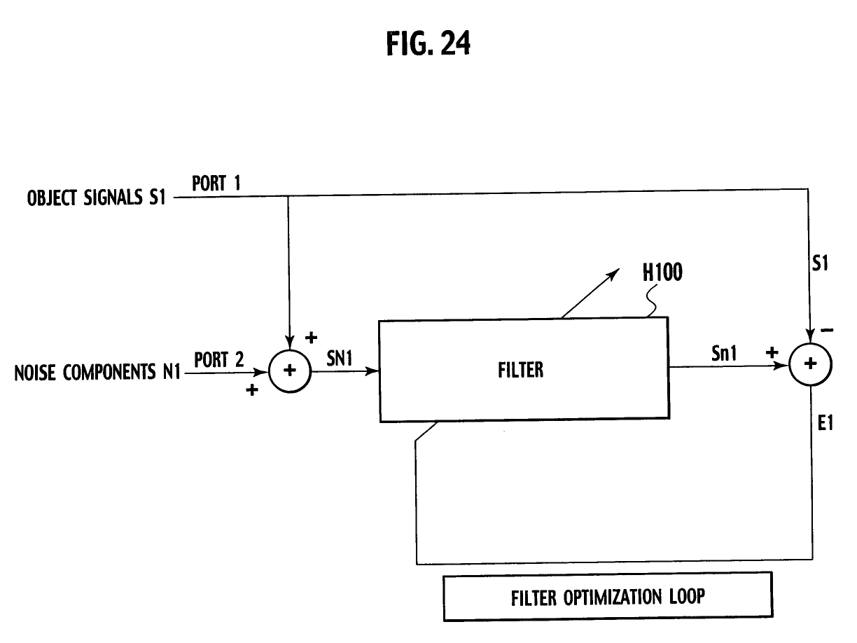

FIG. 24 shows an example of use of the LMS algorithm for the procedure as shown in FIG. 23 in which the “filter calculation” process is performed.

In the case as shown in FIG. 24, object signals S1 to be inputted at time t₀ are used as signals to be inputted into a port 1, and noise components N1 to be inputted at time t₂ are used as signals to be inputted into a port 2. The object signals S1 and the noise components N1 are added to each other, and accordingly pseudo observed signals SN1 into which the object signals and the noise components are simultaneously inputted at time t₂ are generated. A filter H100 is applied to the pseudo observed signals SN1, and accordingly the signals SN1 are converted into signals Sn1. In addition, error signals E1 between Sn1 and S1 is calculated. On the basis of the error signals E1, the filer H100 is updated in a way that the noise reduction ratio becomes larger, or in a way that the error signals E1 become smaller.

When all of the object signals S1 and all of the noise components N1 are inputted, the filter H100 is replaced with the “filter” as shown in FIG. 23.

Object signals S1 (representing speech to be uttered while the car is idling, for example) which is stored into the storage 750 as shown in FIG. 23 at time t₀ are used when the pseudo observed signals are generated in the aforementioned manner. In this respect, the following cases can be conceived for the object signals S1, which are used when a filter calculation is processed for the N th time.

Case 1: signals representing speech uttered by the user, which are stored when a filter is updated for the (N-1)th time. (A learning process is always performed by use of the penultimate speech.)

Case 2: signals representing addition of speeches uttered by the user, which speeches are inputted when the filter is updated from the first time through the (N-1)th time. (All of the inputted speeches are added up so that Case 2 is applied to all of the prospective users. Case 2 is suitable for a family use.)

Case 3: signals representing addition of speeches uttered by the user A, which speeches are inputted when the filter is updated from the (N-x) th time through the (N-1)th time. (Case 3 is applied to a particular speaker, and is suitable for an individual use.)

Case 4: speeches uttered by the user A, which speeches are inputted when the filter is updated from the (N-x)th time through the (N-1)th time. (Case 4 is applied to a particular speaker, and is suitable for an individual use.)

Here, descriptions will be provided for an adaptive algorithm to be used for removing diffusive noise and directional noise, giving an example of application of the adaptive algorithm to the filter and the filter calculating process according to the present invention.

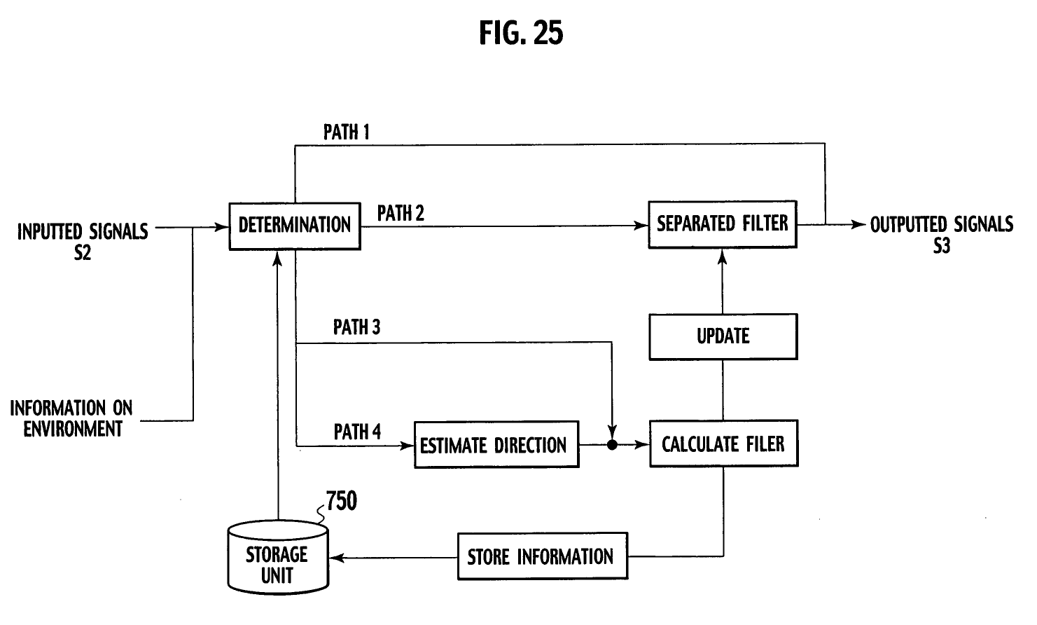

Hereinbelow, descriptions will be provided for outlined operations for processing signals according to the fourth embodiment, with reference to FIG. 25.

A storage unit 750 as shown in FIG. 25 is equivalent to the third storage unit or a combination of the first and the second storage units. Information D0 on object signals which are inputted at time to and information I1 on noise components which are inputted at time t₁ are stored in the storage unit 750. The information D0 includes any one of the following two types of information, or both of the two. One type of information is on object signals which are extracted from the sound signals inputted at time t₀. The other type of information is on sound quality and the incoming direction of the object signals, both of which are estimated from the sound signals inputted at time t₀. The information I1 and information I2, which will be described below, includes any one of the following two types of information, or both of the two. One type of information is on sound quality and the incoming direction of the noise components, both of which are estimated from sound signals inputted at time t₁ or at time t₂. The other type of information is on operational conditions of devices which are extracted from environment information inputted at time t₁ or at time t₂.

When sound signals S2 are inputted at time t₂, the below-listed determinations are made depending on conditions, and the processes are performed.

Condition 4: When the sound signals include only noise components, and when no “difference” exists between the information I1 and the information I2 on noise components inputted at time t₂, the process returns to a state of waiting for sound signals to be inputted.

Condition 5: When the sound signals include only noise components, and when a “difference” in incoming direction of noise components exists between the information I1 and the information I2 on the noise components inputted at time t₂, an “azimuth estimation” process is performed on the noise components, and a “filter calculation” process is performed on the object signals and the noise components. Thus, contents of a “separation filter” are updated updated only).

Condition 6: When the sound signals include only noise components, and when only a “difference” in other than incoming direction of noise components exists between the information I1 and the information I2 on the noise components inputted at time t₂, an “azimuth estimation” process to be performed on the noise components is skipped, and only a “filter calculation” process is performed on the object signals and the noise components. Thus, contents of a “separation filter” are updated (updated only).

Conditions 7: When the sound signals are signals in which object signals and noise components are superposed on each other, and when no “difference” exists between the information I1 and the information I2 on noise components inputted at time t₂, and when no “difference” exists between the information D0 and information D2 on the object signals inputted at time t₂, a “separation filter” process is applied to the sound signals S2, and thereafter the sound signals S2 thus processed are outputted (path 2).

Condition 8: When the sound signals are signals in which object signals and noise components are superposed on each other, and when a “difference” in incoming direction of noise components exists between the information I1 and the information I2 on the noise components inputted at time t₂, an “azimuth estimation” process is performed on the noise components, and a “filter calculation” process is performed on the object signals and the noise components. Thus, contents of the “separation filter” are updated. After the “separation filter” is updated, the “separation filter” process is performed on the sound signals S2, and thereafter the sound signals S2 thus processed are outputted (path 4).

Condition 9: When the sound signals are signals in which object signals and noise components are superposed on each other, and when only a “difference” in other than incoming direction of noise components exists between the information I1 and the information I2 on the noise components inputted at time t₂, an “azimuth estimation” process to be performed on the noise components is skipped, and only a “filter calculation” process is performed on the object signals and the noise components. Thus, contents of the “separation filter” are updated. After the “separation filter” is updated, the “separation filter” process is performed on the sound signals S2, and thereafter the sound signals S2 thus processed are outputted (paths 3 or 4).

Condition 10: When the sound signals are signals in which object signals and noise components are superposed on each other, and when a “difference” in incoming direction of object signals exists between the information D0 and the information D2 on the object signals inputted at time t₂, an “azimuth estimation” process is performed on the object signals, and a “filter calculation” process is performed on the object signals and the noise components. Thus, contents of the “separation filter” are updated. After the “separation filter” is updated, the “separation filter” process is performed on the sound signals S2, and thereafter the sound signals S2 thus processed are outputted (path 4).

Condition 11: When the sound signals are signals in which object signals and noise components are superposed on each other, and when only a “difference” in other than incoming direction of noise components exists between the information D0 and the information D2 on the object signals inputted at time t₂, an “azimuth estimation” process is performed on the object signals, and a “filter calculation” process is performed on the object signals and the noise components. Thus, contents of the “separation filter” are updated. After the “separation filter” is updated, the “separation filter” process is performed on the sound signals S2, and thereafter the sound signals S2 thus processed are outputted (paths 3 or 4).

Condition 12: When the sound signals include only object signals, the sound signals 2 are processed through no “separation filter” (path 1).

According to a technique using the related art, two (or more) microphones are used as a sound input unit, and two channels of signals which are inputted by the user are separated so that the two channels of signals thus separated are transmitted as object signals. When the aforementioned technique using the related art is applied to the present invention, there are two techniques for inputting signals.

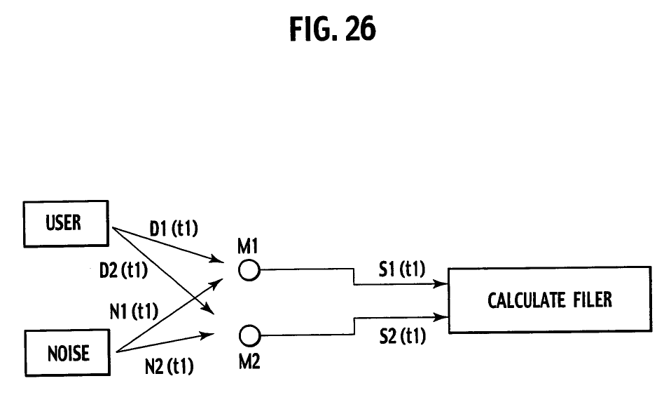

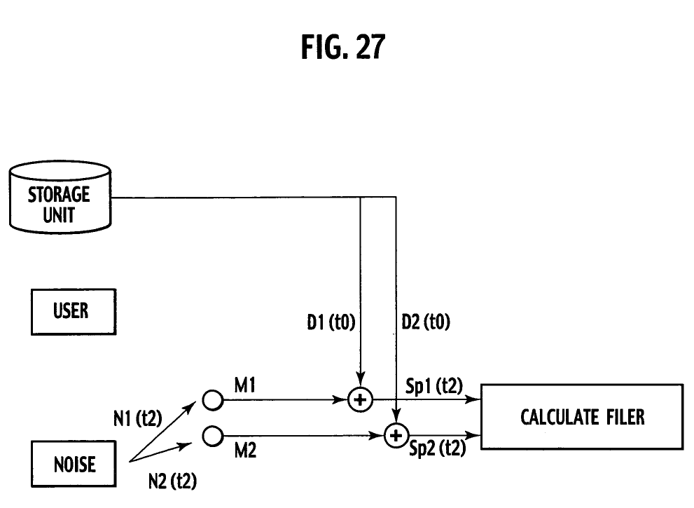

Descriptions will be provided for how signals are inputted when the technique using the related art is applied to the present invention, with reference FIGS. 26 and 27.

FIG. 26 shows how signals are inputted in the case where any one of onditions 7 to 11 is satisfied.

Object signals D1(t₁) which are inputted by the user at time t₁ and noise components N1(t₁) which come from a source of noise at time t, are inputted into a microphone M1. Object signals D2(t₁) which are inputted by the user at time t₁ and noise components N2(t₁) which come from a source of noise at time t₁ are inputted into a microphone M2. In this case, signals S1(t₁) to be inputted from the microphone M1 to a “filter calculation” processing unit at time t₁ can be expressed by
S1(t₁)=D1(t₁)+N1(t₁)

Similarly, signals S2(t₁) to be inputted from the microphone M2 to a “filter calculation” processing unit at time t₁ can be expressed by
S2(t₁)=D2(t₁)+N2(t₁)
It can be understood that S1(t₁) and S2(t₁) denote observed signals, which represent sound signals which can be observed real time, and which are acquired by use of each of the microphones.

By use of inputted observed signals, the “filter calculation” processing unit calculates the “separation filter” for separating the observed signals into object signals and noise components.

FIG. 27 shows how signals are inputted in the case where any one of Conditions 5 to 6 is satisfied.

Noise components N1(t₂) which come from a source of noise at time t₂ are inputted into the microphone M1, and noise components N2(t₂) which come from a source of noise at time t₂ are inputted into the microphone M2. Object signals D1(t₀) to be stored into the storage unit 750 from the microphone M1 at time t₀ which is earlier than time t₂ are added to the noise components N1(t₁). Object signals D2(t₀) to be stored into the storage unit 750 from the microphone M2 at time to which is earlier than time t₂ are added to the noise components N2(t₂).

Sp1(t₂) to be inputted into the “filter calculation” processing unit should be primarily expressed by
Sp1(t₂)=D1(t₂)+N1(t₂)
However, in the case of the configuration as shown in FIG. 27, D1(t₀) is used as substitutive characteristics for D1(t₂). For this reason, the Sp1(t₂) is expressed by
Sp1(t₂)=D1(t₀)+N1(t₂)
Similarly,
Sp2(t₂)=D2(t₀)+N2(t₂)
The “filter calculation” processing unit calculates the “separation filter” for separating the pseudo observed signals Sp1(t₂) and Sp2(t₂) into object signals and noise components by use of the pseudo observed signals Sp1(t₂) and Sp2(t₂) which have been generated in a pseudo manner. At this time, the object signals D1(t₀) and D2(t₀) are used as if they were object signals to be inputted by a virtual user at time t₂.

In the case where pseudo observed signals are generated by use of object signals, which have been previously stored, and the pseudo observed signals are used through the aforementioned configuration, contents of the filter 630 can be updated into contents whose noise reduction ratio is improved, even if object signals are not inputted.

In a case where the determination unit 640 analyzes sound signals which are acquired from the sound input unit 620 and obtains a result indicating that noise signals are negligible against object signals; the determination unit 640 determines that the sound signals be stored as the object signals into any one of the storage units 650, 651 and 652. In a case where there exists no object signals, the determination unit 640 determines that the sound signals be stored as the noise components into any one of the storage units 650, 651 and 652. This makes it possible to generate object signals at time t₁ and observed signals at time t₁ from object signals at time to and noise components, which are stored earlier than time t₁, in a pseudo manner, and makes it possible to use an adaptive algorithm such as the LMS algorithm, accordingly enabling the filter to be updated. For this reason, the present invention can be carried out even if there is only one channel for the input system.

In addition, if the filter calculation unit 660 updates the filter when the user input no object signals, this makes it possible to obtain noise components precisely. As a consequence, the filter can be updated into a more adaptive filter.

As above described, the fourth embodiment of the present invention brings about the following effects.

Generally, in the case of a speech recognition device and a hands-free telephone which are used in a car compartment, a noise reduction algorithm is introduced, which suppresses driving noise whose energy is concentrated on a low frequency band by use of a fixed coefficient filter including a high-pass filter.

Additionally, it has been proposed that the cutoff frequency for the high pass filter be changed depending on inputted signals as a case of introduction of simple adaptive techniques. According to this method, the adaptation is carried out each time signals are inputted. However, the calculation is kept in a small amount since the adaptive scope of the filter is limited. An object of these techniques is to reduce stationary noise in the car compartment.

On the other hand, a directional noise reduction technique has been proposed, which has an effect to reduce noise coming in a specific direction whether the noise may be stationary or non-stationary. However, the directional noise reduction technique requires a larger amount of calculation. This makes it difficult to use the directional noise reduction technique in an environment in the car compartment.

Noise which is regarded as being stationary in the car compartment includes noise which is always non-stationary. For example, road noise and engine noise are generally regarded as being highly stationary. However, it is thought that these noises will actually vary depending on the vehicle speed, road conditions as well as deterioration in the tires, the engine and the exhaust system over a long period of time. Even if a high-pass filter to be set up with a fixed coefficient is used, it is difficult to remove all the noises. For this reason, a highly adaptive noise reduction technique is needed to cope with this problem through observing noise reduction in the car compartment over a long period of time.

Furthermore, much non-stationary noise also exists in the car compartment. Such non-stationary noise includes, for example, speech uttered by a fellow passenger, change in the surrounding environment, rain sound, sound which is caused when the car is running through the air. These noises can not be removed by use of a technique which has been devised for the purpose of reducing stationary noise. In this case, if noise whose incoming direction is apparent is removed, energy of the noise can be reduced to a large extent. However, the two cases need a large amount of calculation. For this reason, reduction in an amount of calculation is an issue to be solved.

The object of the fourth embodiment of the present invention is to solve the aforementioned problem, thus providing a sound input device including a highly adaptive noise reduction unit which can be applied to a special environment such as the inside of the car compartment.

According to the fourth embodiment of the present invention, the sound input device is configured to reduce an amount of calculation by updating the filter for removing noise components from inputted sound only when characteristics associated with the sound input system vary to a large extent, instead of by constantly updating the filter sequentially, in a case where the filter is intended to be kept in an effective condition, for the purpose of solving the problem. In addition, the sound input device is configured to include the noise reduction unit using the new adaptive learning method which enables the S/N ratio to be kept at a certain level

According to the fourth embodiment of the present invention, the sound input device is configured to use the new adaptive learning method which reduces an amount of calculation by updating the filter only when the characteristics associated with the sound input system vary to a large extent. This makes it possible to provide the sound input device including the highly adaptive noise reduction unit which can be applied to a special environment such as the inside of the car compartment.

The entire content of a Patent Application No. TOKUGAN 2004-229204 with a filing date of Aug. 5, 2004 and a Patent Application No. TOKUGAN 2004-270772 with a filing date of Sep. 17, 2004 in Japan is hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A sound input device comprising:
a start-of-a-learning-operation determining unit configured to determine a time when a filter is started to be learned, the filter being for removing noise from sound signals detected in a car compartment while leaving object signals; and
a frequency band determining unit configured to determine a frequency band for which the filter is learned after the time when the filter is started to be learned is determined.

2. The sound input device of claim 1,
wherein the sound input device detects sound, in which the object signals and the noise exist in a mixed manner, by use of a plurality of acoustic sensors, and thereby acquires a plurality of sound signals in which the object signals and the noise exist in the mixed manner, accordingly performing Independent Component Analysis for obtaining the filter for separating at least one object signal from the plurality of sound signals through learning repetitions, and
wherein the frequency band determining unit comprises:
a band dividing unit configured to divide an acoustic frequency band into a plurality of divided frequency bands;
an evaluation unit configured to calculate a discrimination level for evaluating the filter's performance in separating object speech which is obtained through the learning for each of the divided frequency bands in the course of the learning; and
a determination unit configured to determine a divided frequency band, on which the learning is performed, out of the divided frequency bands on the basis of the discrimination levels.

3. The sound input device of claim 2, wherein the determination unit determines that the learning be not performed, at and after time t, on a divided frequency band in which a rate of change between a discrimination level calculated at time t and a discrimination level calculated at time t−m (m>0) does not exceed a previously-set threshold value.

4. The sound input device of claim 2, wherein the determination unit again determines a divided frequency band on which the learning is performed at time t+i (i>0) when the determination unit determines a divided frequency band on which the learning is performed at time t.

5. The sound input device of claim 2, wherein, with regard to a divided frequency band in which a rate of change between a discrimination level calculated at time t and a discrimination level calculated at time t−m (m>0) is larger than a previously-set threshold value, the determination unit determines that:
the learning be performed from time t through a time when it is determined that a divided frequency band on which the learning is performed at and after time t is determined in a case where the divided frequency band on which the learning is performed at and after time t is determined; and
the learning be performed from t through a time when repetition of the learning is completed in a case where the repetition of the learning is completed while a divided frequency band on which the learning is performed at and after time t is not determined.

6. The sound input device of claim 2, wherein the determination unit ends repetition of the learning when the number of learning repetitions reaches a prescribed value.

7. The sound input device of claim 2, wherein the discrimination level represents a correlation coefficient in a local time section between two separated signals which are obtained by applying a filter process by use of the filter to the plurality of sound signals, and
wherein a rate of change between two of the discrimination levels represent a norm of a difference vector between the two discrimination levels.

8. The sound input device of claim 2, wherein the discrimination level represents a correlation coefficient in a local time section between two separated signals which are obtained by applying a filter process by use of the filter to the plurality of sound signals, and
wherein a rate of change between two of the discrimination levels represent a norm of a difference vector between two smoothed discrimination levels which are obtained by averaging the two discrimination levels respectively in local frequency sections.

9. The sound input device of claim 2,
wherein the band dividing unit divides the frequency band into a plurality of blocks, and
wherein the determination unit determines that the learning be preformed on none of the divided frequency bands which belong to a block including a divided frequency band on which it is determined that no learning is performed.

10. The sound input device of claim 1, further comprising:
a microphone configured to detect sound;
a sound input unit configured to input the sound which is detected by the microphone; and
a filter configured to remove noise components from the sound which is inputted by the sound input unit,
wherein the start-of-a-learning-operation determining unit comprises:
a first storage unit into which information on noise is stored;
a filter calculation unit configured to update contents of the filter, and store information on noise, which is used for the updating, into the first storage unit; and
a determination unit configured to determine that the filter calculation unit be operated when sound signals to be acquired by the sound input unit include object signals which are inputted by a user, and when noise components in the sound signals to be acquired by the sound input unit are different in kind from noise components which are stored in the first storage unit.

11. The sound input device of claim 1, further comprising:
a microphone configured to detect sound;
a sound input unit configured to input the sound which is detected by the microphone; and
a filter configured to remove noise components from the sound which is inputted by the sound input unit,
wherein the start-of-a-learning-operation determining unit comprises:
a second storage unit into which information on object signals is stored;
a filter calculation unit configured to update contents of the filter, and store information on object signals, which is used for the updating, into the second storage unit; and
a determination unit configured to determine that the filter calculation unit be operated when sound signals to be acquired by the sound input unit include object signals which are inputted by a user, and when the objects signals are different in kind from object signals which are stored in the second storage unit.

12. The sound input device of claim 1, further comprising:
a microphone configured to detect sound;
a sound input unit configured to input the sound which is detected by the microphone; and
a filter configured to remove noise components from the sound which is inputted by the sound input unit,
wherein the start-of-a-learning-operation determining unit comprises:
a first storage unit into which information on noise is stored;
a second storage unit into which information on object signals is stored;
a filter calculation unit configured to update contents of the filter, store information on object signals, which is used for the updating, into the second storage unit, and store information on noise, which is used for the updating, into the first storage unit; and
a determination unit configured to determine that the filter calculation unit be operated in any one of the following two cases: one case where sound signals to be acquired by the sound input unit include object signals which are inputted by a user, and the objects signals are different in kind from object signals which are stored in the second storage unit; and the other case where noise components included in the sound signals to be acquired by the sound input unit are different in kind from noise components which are stored in the first storage unit.

13. The sound input device of claim 1, further comprising:
two or more microphones configured to detect sound;
a sound input unit configured to input the sound which is detected by the microphones; and
a filter configured to remove noise components from the sound which is inputted by the sound input unit,
wherein the start-of-a-learning-operation determining unit comprises:
a first storage unit into which information on noise is stored;
a filter calculation unit configured to update contents of the filter, and store information on noise, which is used for the updating, into the first storage unit; and
a determination unit configured to determine that the filter calculation unit be operated when sound signals to be acquired by the sound input unit include object signals which are inputted by a user, and when noise components included in the sound signals to be acquired by the sound input unit are different in incoming direction from noise components which are stored in the first storage unit.

14. The sound input device of claim 1, further comprising:
two or more microphones configured to detect sound;
a sound input unit configured to input the sound which is detected by the microphones; and
a filter configured to remove noise components from the sound which is inputted by the sound input unit,
wherein the start-of-a-learning-operation determining unit comprises:
a second storage unit into which information on object signals is stored;
a filter calculation unit configured to update contents of the filter, and store information on object signals, which is used for the updating, into the second storage unit; and
a determination unit configured to determine that the filter calculation unit be operated when sound signals to be acquired by the sound input unit include object signals which are inputted by a user, and when the objects signals are different in incoming direction from object signals which are stored in the second storage unit.

15. The sound input device of claim 1, further comprising:
two or more microphones configured to detect sound;
a sound input unit configured to input the sound which is detected by the microphones; and
a filter configured to remove noise components from the sound which is inputted by the sound input unit,
wherein the start-of-a-learning-operation determining unit comprises:
a first storage unit into which information on noise is stored;
a second storage unit into which information on object signals is stored;
a filter calculation unit configured to update contents of the filter, store information on noise, which is used for the updating, into the first storage unit, and store information on object signals, which is used for the updating, into the second storage unit; and
a determination unit configured to determine that the filter calculation unit be operated in any one of the following two cases: one case where sound signals to be acquired by the sound input unit include object signals which are inputted by a user, and the objects signals are different in incoming direction from object signals which are stored in the second storage unit; and the other case where noise components included in the sound signals are different in incoming direction from noise components which are stored in the first storage unit.

16. The sound input device of claim 10,
further comprising a second storage unit into which information on object signals is stored,
wherein the determination unit analyzes the sound signals to be inputted by the sound input device, determines that the sound signals be stored as object signals into the second storage unit in a case where it is obtained as a result of the analysis that the noise components are negligible against the object signals, and determines whether or not the sound signals to be inputted by the sound input unit is constituted of only noise components; and
wherein the filter calculation unit changes contents of the filter to be used at time t1 by use of the object signals, which are stored into the second storage unit at time t0 earlier than time t1, and pseudo observed signals generated from the object signals thus stored into the second storage unit and sound signals, which are inputted at time t1 by the sound input unit, and which it is determined that are constituted of only noise components by the determination unit.

17. The sound input device of claim 10,
further comprising a second storage unit into which information on object signals is stored,
wherein the determination unit analyzes the sound signals to be acquired by the sound input device, determines that the sound signals be stored as object signals into the second storage unit in a case where it is obtained as a result of the analysis that the noise components are negligible against the object signals, and determines that the sound signals are stored as noise components into the first storage unit in a case where it is obtained as a result of the analysis that no object signals exist in the sound signals; and
wherein the filter calculation unit changes contents of the filter to be used at time t1 by use of the object signals, which are stored into the second storage unit, and pseudo observed signals generated from the object signals thus stored in the second storage unit and the noise components, which are stored in the first storage unit.

18. The sound input device of claim 10,
further comprising a switch through which the user informs the system of whether or not object signals are inputted,
wherein the determination unit determines that the object signals have been inputted when the switch is turned on.

19. The sound input device of claim 10,
further comprising an information unit configured to gather information on other than the sound,
wherein the determination unit determines that the filter calculation unit be operated in a case where the noise can be regarded as having varied on the basis of the information on other than the noise which is gathered by the information unit.

20. The sound input device of claim 10, wherein the filter calculation unit updates the filter when the user input no object signals.

21. A sound input device comprising:
a microphone configured to detect sound;
a sound input unit configured to input the sound to be detected by the microphone;
a filter configured to remove noise components from the sound to be inputted by the sound input unit;
a third storage unit in which information on object signals and noise is stored;
a determination unit configured to determine whether the sound to be inputted by the sound input unit represents the object signals or is constituted of only the noise components; and
a filter calculation unit configured to change contents of the filter to be used at time t1 by use of the object signals, which are stored into the third storage unit at time t0 earlier than time t1, and pseudo observed signals generated from the object signals thus stored in the third storage unit and noise components which are inputted by the sound input unit at time t1.

22. A method for inputting sound, comprising:
determining a time when a filter is started to be learned, the filter being for removing noise from sound signals detected in a car compartment while leaving object signals; and
determining a frequency band for which the filter is learned after the time when the filter is started to be learned is determined.

23. A computer program product for inputting sound, comprising:
a computer code for determining a time when a filter is started to be learned, the filter being for removing noise from sound signals detected in a car compartment while leaving object signals; and
a computer code for determining a frequency band for which the filter is learned after the time when the filter is started to be learned is determined.
